(19) United States
(12) Patent Application Publication
(10) Pub. No.: US 2012/0254247 A1
(43) Pub. Date: Oct. 4, 2012

(54) COMPUTER PRODUCT AND DESTINATION DETERMINING METHOD

(75) Inventor: Takuya SAKAMOTO, Kawasaki (JP)

(73) Assignee: FUJITSU LIMITED, Kawasaki-shi (JP)

(21) Appl. No.: 13/335,411

(22) Filed: Dec. 22, 2011

(30) Foreign Application Priority Data
Mar. 30, 2011 (JP) 2011-076816

(51) Int. Cl. G06F 17/30

(52) U.S. Cl. 707/784; 707/E17.005

(57) ABSTRACT

A computer-readable medium stores therein a program that causes a computer having access to a database that stores therein identification information that is for each user among multiple users and is associated with a destination of each user, to execute a process. The process includes receiving from a first portable terminal of a given user, the identification information of the given user and receiving from each second portable terminal within a communication range of the first portable terminal, the identification information of each user of the second portable terminals; identifying, by referring to the database, the destination of each user of the second portable terminals, stored associated with the identification information received for each user of the second portable terminals; determining the destination of the given user, based on the identified destinations; and outputting associated with the received identification information of the given user, results obtained at the determining.

### CROSS REFERENCE TO RELATED APPLICATIONS

This application is based upon and claims the benefit of priority of the prior Japanese Patent Application No. 2011-076816, filed on Mar. 30, 2011, the entire contents of which are incorporated herein by reference.

### FIELD

The embodiments discussed herein are related to a destination determining program and a destination determining method that determine a user's destination.

### BACKGROUND

Conventionally, in offices, a destination board system is frequently used in which an employee, at the time of departure, writes down on a common whiteboard or blackboard his destination to inform others of his present whereabouts. In recent years, an electronic destination board system as well is frequently used in which employees' destination record is controlled by a server and the employees update the destination record stored in a database on the server so that other employees can confirm each employee's destination record from the database on the server by means of a browser, etc.

If the employee forgets to update his destination stored in the destination board database on the server or if after updating his destination on the destination board, the employee changes the place for which he is headed, a problem arises in that his whereabouts cannot be identified. In this connection, for example, a technology (hereinafter, “conventional technology 1”) is known of installing a radio frequency identification (RFID) in a conference room to cause a portable terminal held by the employee to read the information of the installed RFID and automatically update the destination of the employee in the database on the server, based on the read-in RFID information (refer to, e.g., Japanese Laid-Open Patent Publication No. 2007-102392).

For example, a technology (hereinafter, “conventional technology 2”) is known of estimating positional information of a moving portable terminal according to the positional information of a fixed personal computer (PC) (refer to, e.g., Japanese Laid-Open Patent Publication NO. 2003-203287).

For example, a technology is known of estimating the position of a portable terminal, based on the positional information of a global positioning system (GPS) of the portable terminal, login information of the portable terminal, conference room reservation information, entrance and exit history information, and schedule management information. A technology (hereinafter, “conventional technology 3”) is known of displaying indication that the presumed location of the portable terminal and the destination registered in the destination board do not coincide (refer to, e.g., Japanese Laid-Open Patent Publication No. 2009-251624).

There is a problem, however, that the conventional technologies are still incapable of identifying the whereabouts of the employee when the employee forgets to update his destination stored in the destination board database on the server or after updating his destination on the destination board, the employee changes his destination. For example, the conventional technologies 1 and 2 are incapable of automatically updating the destination on the destination board, at a destination where no RFID or PC is installed.

For example, the conventional technology 3 is incapable of automatically updating the destination on the destination board since, in the case of using the GPS, the positional information of the GPS may be unacquirable inside a building such as an office. For example, even if the GPS can be used inside a building such as an office, an accurate destination cannot be identified inside the building. While the information ordinarily used on the destination board is the name of place (e.g., the name of a conference room), the information acquired by the GPS is the information of longitude, latitude, etc. Therefore, it is necessary to prepare beforehand the information in which the information of longitude, latitude, etc., is associated with the name of the place and perform processing of associating the information acquired by use of the GPS with the name of the place when the destination board is in operation.

For example, in the conventional technology 3, to use the login information of the portable terminal, the conference room reservation information, the entrance and exit history information, and the schedule management information, it is assumed that, for each of the types of information, the employee inputs the same information as input to the destination board. It is necessary to perform accurate destination input and appropriate destination updating according to a schedule change, etc., with respect to the login information of the portable terminal, the conference room reservation information, the entrance and exit history information, and the schedule management information in addition to the destination board. Therefore, if the employee forgets to update the login information of the portable terminal, the conference room reservation information, the entrance and exit history information, and the schedule management information, the whereabouts of the employee cannot be identified.

### SUMMARY

According to an aspect of an embodiment, a computer-readable medium stores therein a destination determining program that causes a computer to execute a process. The computer has access to a database that stores therein identification information that is for each user among a plurality of users and is associated with a destination of each user. The process includes receiving from a first portable terminal of a given user among the plurality of users, the identification information of the given user and receiving from each second portable terminal within a communication range of the first portable terminal, the identification information of each user of the second portable terminals; identifying, by referring to the database, the destination of each user of the second portable terminals, stored in association with the identification information received for each user of the second portable terminals; determining the destination of the given user, based on the identified destinations; and outputting in association with the received identification information of the given user, results obtained at the determining.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram of one example of the present invention.

FIG. 2 is an explanatory diagram of one example of a board management system.

FIG. 3 is a block diagram of an exemplary hardware configuration of a server 200.

FIG. 4 is a block diagram of a hardware example of a portable terminal.

FIG. 5 is an explanatory diagram of one example of a destination database 210 according to the first embodiment.

FIG. 6 is an explanatory diagram of one example of a nearby-user ID database 220-1 according to a first embodiment.

FIG. 7 is a block diagram of an exemplary functional configuration of each of a portable terminal 201-x and the server 200 according to the first embodiment.

FIG. 8 is an explanatory diagram of an example of exchange of the user ID between a portable terminal 201-1 and a nearby portable terminal according to the first embodiment.

FIG. 9 is an explanatory diagram of an example of notification information according to the first embodiment.

FIG. 10 is an explanatory diagram of an example of the destination determination concerning the user of the portable terminal 201-1 according to the first embodiment.

FIG. 11 is a flowchart of one example of the user ID exchange by the portable terminal 201-x according to the first embodiment.

FIG. 12 is a flowchart of one example of the user ID exchange by the portable terminal 201-y according to the first embodiment.

FIG. 13 is a flowchart of one example of transmission of notification information by the portable terminal 201-x according to the first embodiment.

FIG. 14 is a flowchart of one example of the destination determination by the server 200 according to the first embodiment.

FIG. 15 is a flowchart of updating processing by the server 200 according to the first embodiment.

FIG. 16 is an explanatory diagram of one example of a destination database 210 according to a second embodiment.

FIG. 17 is an explanatory diagram of an example of the destination determination concerning the user of the portable terminal 201-1 according to the second embodiment.

FIG. 18 is a flowchart of one example of the destination determination by the server 200 according to the second embodiment.

FIG. 19 is a flowchart of the updating processing by the server 200 according to the second embodiment.

FIG. 20 is an explanatory diagram of one example of the destination database 210 according to a third embodiment.

FIG. 21 is an explanatory diagram of an example of the destination determination concerning the user of the portable terminal 201-1 according to the third embodiment.

FIG. 22 is a flowchart of one example of the destination determination by the server 200 according to the third embodiment.

FIG. 23 is a flowchart of the updating processing by the server 200 according to the third embodiment.

FIG. 24 is an explanatory diagram of one example of the nearby-user ID database 220-1 according to a fourth embodiment.

FIG. 25 is an explanatory diagram of an example of the user ID exchange between the portable terminal 201-1 and the nearby portable terminal according to the fourth embodiment.

FIG. 26 is an explanatory diagram of an example of the notification information according to the fourth embodiment.

FIG. 27 is an explanatory diagram of an example of the destination determination concerning the user of the portable terminal 201-1 according to the fourth embodiment.

FIG. 28 is a flowchart of one example of the user ID exchange by the portable terminal 201-x according to the fourth embodiment.

FIG. 29 is a flowchart of one example of the destination determination by the server 200 according to the fourth embodiment.

FIG. 30 is an explanatory diagram of one example of the destination database 210 according to a fifth embodiment.

FIG. 31 is an explanatory diagram of an example of the exchange of the user ID between the portable terminal 201-1 and the nearby portable terminal according to the fifth embodiment.

FIG. 32 is an explanatory diagram of an example of the notification information according to the fifth embodiment.

FIG. 33 is an explanatory diagram of an example of determining the destination of the user of the portable terminal 201-1 according to the fifth embodiment.

FIG. 34 is an explanatory diagram of an example of determining the destination of the user of the portable terminal 201-1 according to the fifth embodiment.

FIG. 35 is a flowchart of the destination determination by the server 200 according to the fifth embodiment.

FIG. 36 is a flowchart of the destination determination by the server 200 according to the fifth embodiment.

FIG. 37 is a flowchart of the destination determination by the server 200 according to the fifth embodiment.

FIG. 38 is a flowchart of the updating processing by the server 200 according to the fifth embodiment.

### DESCRIPTION OF EMBODIMENTS

Preferred embodiments of the present invention will be explained with reference to the accompanying drawings.

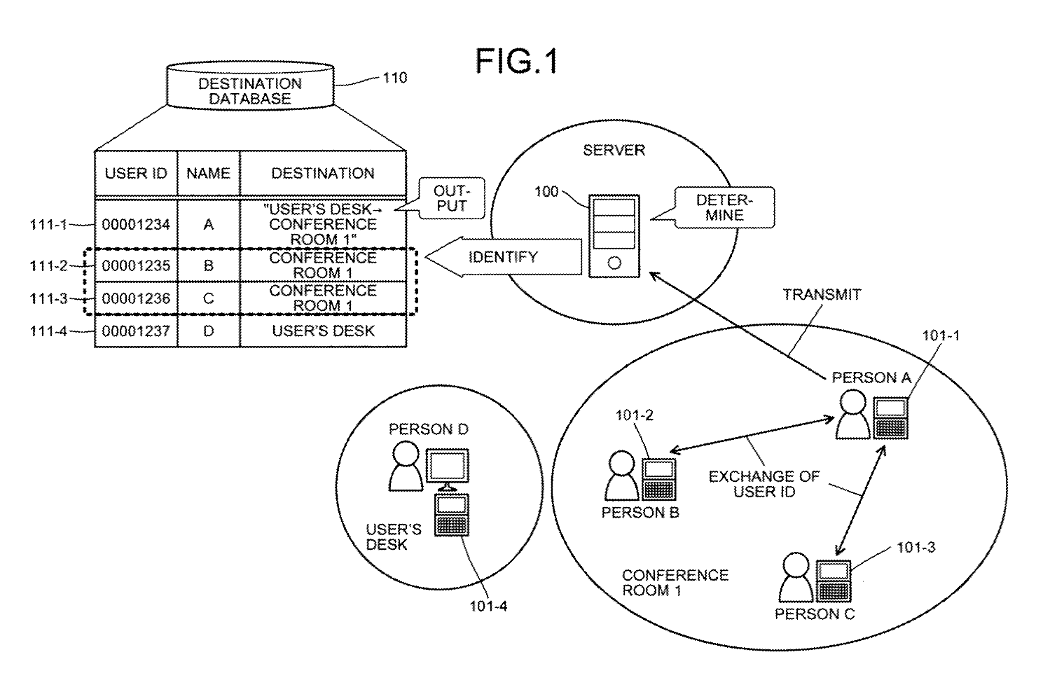

FIG. 1 is an explanatory diagram of one example of the present invention. A server 100 manages the destinations of plural users, using a destination database 110. The destination database 110 has fields for a user ID to identify a user, the user's name, and destination. With information set into each of the fields, destination information (e.g., destination records 111-1 to 111-4) is stored as records.

For example, the user ID of person A is “00001234”, the user ID of person B is “00001235”, the user ID of person C is “00001236”, and the user ID of person D is “00001237”.

Description will now be made respect to the destination of person A. For example, a portable terminal 101-1 of person A connects with other portable terminals within communication range, by short-range radio communication. For example, Bluetooth and Zigbee can be given as an example of the short-range radio communication. The portable terminal 101-1 connects with a portable terminal 101-2 of person B and a portable terminal 101-3 of person C. The portable terminal 101-1 receives from the portable terminal 101-2, the user ID of the user of the portable terminal 101-2. The portable terminal 101-1 receives from the portable terminal 101-3, the user ID of the user of the portable terminal 101-3.

The portable terminal 101-1 notifies the server 100 of notification information that includes the user ID of the user of the portable terminal 101-1, the received user ID of the user of the portable terminal 101-2, and the received user ID of the user of the portable terminal 101-3.

The server 100, upon receiving a connection from the portable terminal 101-1, receives the notification information from the portable terminal 101-1. The server 100 refers to the destination database 110 and identifies the destination in the destination record that includes the user IDs of the users of the portable terminal 101-2 and the portable terminal 101-3 within the communication range of the portable terminal 101-1 included in the notification information. The destination in the destination record 111-2 is “conference room 1” and the destination in the destination record 111-3 is “conference room 1”.

The server 100, based on the identified destination in the destination record 111-2 and the destination record 111-3, determines the destination of the user of the portable terminal 101-1, which is originator of the notification information. The server 100 outputs “conference room 1” as the determined destination, to the destination field of the destination record 111-1 that includes the user ID of the user of the portable terminal 101-1 that is stored in the destination database 110.

The first embodiment indicates an example of determining, as the destination of a given user, the destination of the highest count among the destination of a given user and the destinations of other users within a short distance from the given user.

The second embodiment indicates an example of determining, as the destination of a given user, the destination of the most recent updating date and time, among the destination of the given user and the destinations of other users within a short distance from the given user.

The third embodiment indicates an example of determining, as the destination of a given user, the destination of the user having the largest number of updates among the number of times the given user updated the destination and the number of times other users within a short distance from the given user updated the destination.

The fourth embodiment determines, as the destination of a given user, the destination of the user of a portable terminal that is greatest in the received signal strength of the signal between the portable terminal carried by another user within a short distance from the given user and the portable terminal carried by the given user.

The fifth embodiment indicates an example of combining a given user's destination determining methods of the first to the fourth embodiments.

The first embodiment indicates an example of determining, as the destination of a given user, the destination of the highest count among the destination of the given user and the destinations of other users within a short distance from the given user.

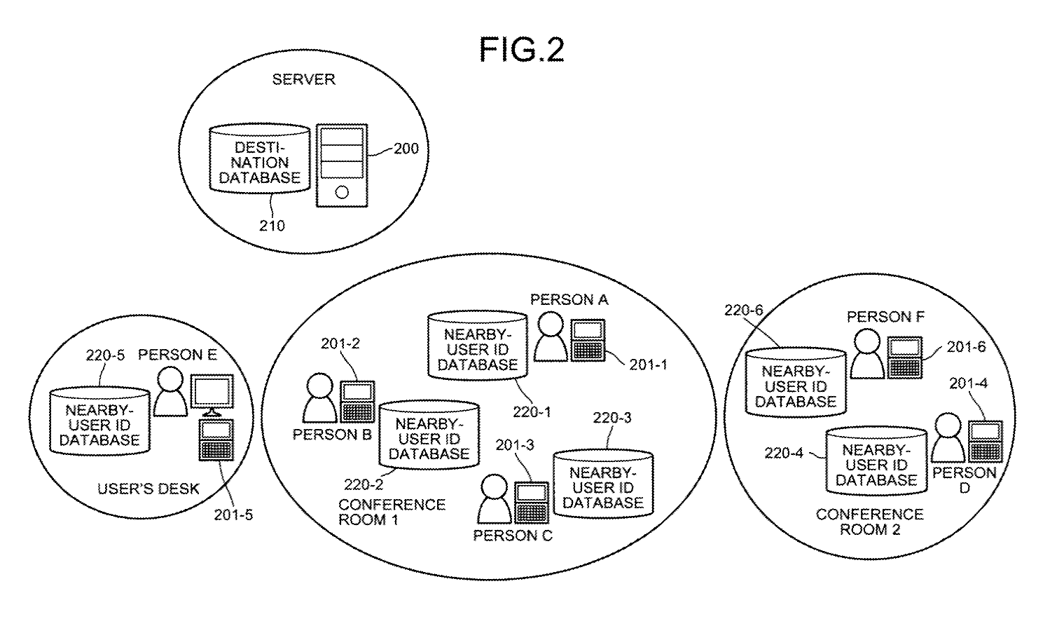

FIG. 2 is an explanatory diagram of one example of a board management system. FIG. 2 depicts the board management system that manages a user's destination board. It is assumed that plural users, when changing locations, carry the portable terminals 201-1 to 201-i (i≧2), respectively. The portable terminals 201-1 to 201-i have nearby-user ID databases 220-1 to 220-i, respectively. Each portable terminal is further assumed to have pre-registered therein, the user ID of the user carrying the portable terminal.

In FIG. 2, persons A to C are in conference room 1, person D and person F are in conference room 2, and person E is at his desk. Persons A to F carry the portable terminals 201-1 to 201-6, respectively.

A server 200 manages the destination of each user. It is assumed that the server 200 is arranged in a server room. The server 200 has a destination database 210. The first embodiment describes an example of estimating the whereabouts of person A and automatically updating the destination of person A. In the first embodiment, the server 200 manages the destination board and executes processing associated with this destination determination. Configuration is not limited hereto and a device different from the device that manages the destination board may execute the processing associated with this destination determination.

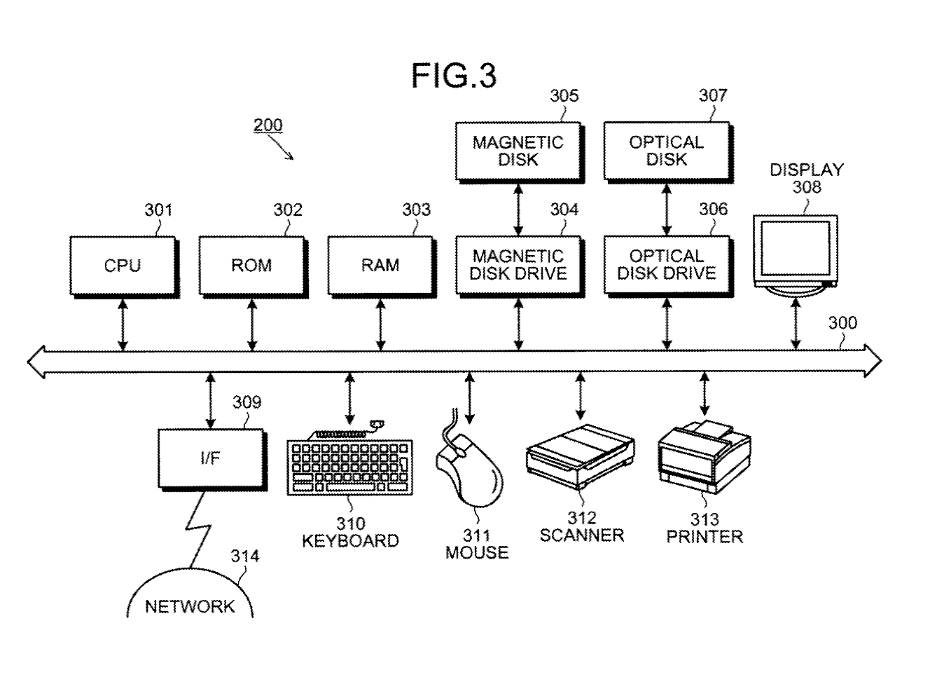

FIG. 3 is a block diagram of an exemplary hardware configuration of the server 200. As depicted in FIG. 3, the server 200 includes a central processing unit (CPU) 301, a read-only memory (ROM) 302, a random access memory (RAM) 303, a magnetic disk drive 304, a magnetic disk 305, an optical disk drive 306, an optical disk 307, a display 308, an interface (I/F) 309, a keyboard 310, a mouse 311, a scanner 312, and a printer 313, respectively connected by a bus 300.

The CPU 301 governs overall control of the server 200. The ROM 302 stores therein programs such as a boot program. The RAM 303 is used as a work area of the CPU 301. The magnetic disk drive 304, under the control of the CPU 301, controls the reading and writing of data with respect to the magnetic disk 305. The magnetic disk 305 stores therein data written under control of the magnetic disk drive 304.

The optical disk drive 306, under the control of the CPU 301, controls the reading and writing of data with respect to the optical disk 307. The optical disk 307 stores therein data written under control of the optical disk drive 306, the data being read by a computer.

The display 308 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 308.

The I/F 309 is connected to a network 314 such as a local area network (LAN), a wide area network (WAN), and the Internet through a communication line and is connected to other apparatuses and portable terminals 201-1 to 201-i through the network 314. The I/F 309 administers an internal interface with the network 314 and controls the input/output of data from/to external apparatuses or the portable terminals 201-i. For example, a modem or a LAN adaptor may be employed as the I/F 309.

The keyboard 310 includes, for example, keys for inputting letters, numerals, and various instructions and performs the input of data. Alternatively, a touch-panel-type input pad or numeric keypad, etc. may be adopted. The mouse 311 is used to move the cursor, select a region, or move and change the size of windows. A track ball or a joy stick may be adopted provided each respectively has a function similar to a pointing device.

The scanner 312 optically reads an image and takes in the image data into the server 200. The scanner 312 may have an optical character reader (OCR) function as well. The printer 313 prints image data and text data. The printer 313 may be, for example, a laser printer or an ink jet printer.

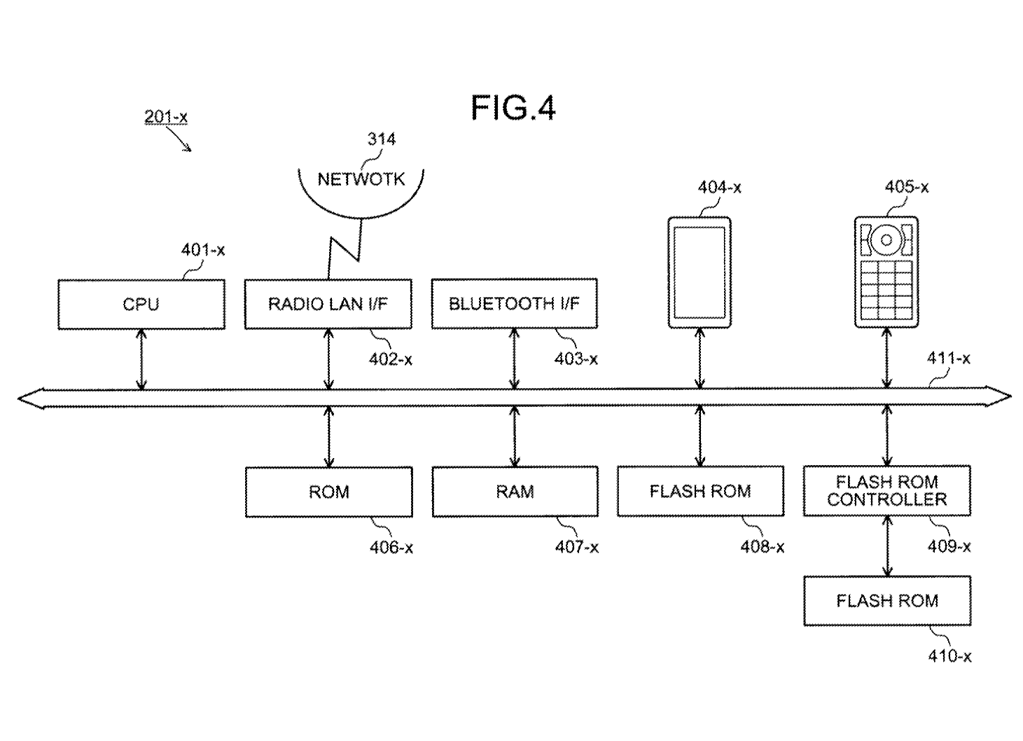

FIG. 4 is a block diagram of a hardware example of the portable terminal. As depicted in FIG. 4, the portable terminal 201-x (x=1 to i) has a CPU 401-x, a radio LAN I/F 402-x, a Bluetooth I/F 403-x, a display 404-x, a keyboard 405-x, a ROM 406-x, and a RAM 407-x. The portable terminal 201-x has a flash ROM 408-x, a flash ROM controller 409-x, and a flash ROM 410-x. The CPU 401-x, the display 404-x, the keyboard 405-x, the ROM 406-x, the RAM 407-x, the flash ROM 408-x, and the flash ROM controller 409-x are connected to one another by way of a bus 411-X.

The CPU 401-x governs overall control of the portable terminal 201-x and has a register, a core, and a cache. The display 404-x displays not only a cursor, an icon, and a toolbox but also data of a document, an image, functional information, etc. For example, a TFT liquid crystal display, etc., can be employed for the display 404-x. The keyboard 405-x has keys for inputting figures, various instructions, etc., and input data. The keyboard 405-x may be a touch panel, a numeric keypad, etc.

The Bluetooth I/F 403-x is directly connected with other portable terminals 201-x by the short-range radio communication. The Bluetooth I/F 403-x is in charge of an internal interface with other portable terminal 201-x and controls the input/output of data from and to other portable terminal 201-x. For example, when the Bluetooth is used for the short-range radio communication, pairing is set beforehand to enable mutual communication with other portable terminal. Alternatively, the pairing may be performed by automatically sending a common authentication key between the portable terminals when the Bluetooth I/F of another portable terminal 201-y (y=1 to i≠x) is found.

The radio LAN I/F 402-x connects to a network 314 such as local area network (LAN) through radio communication and connects to the server 200 and other portable terminals 201-y by way of the network 314. The radio LAN I/F 402-x administers an internal interface with the network and controls the input/output of the data from/to the server 200 and other portable terminals 201-x. For example, a modem, a LAN adaptor, etc., can be employed as the radio LAN I/F 402-x.

The ROM 406-x stores programs such as a boot program. The RAM 407-x is used as a work area of the CPU 401-x. The flash ROM 408-x stores system software such as OS and application programs. The RAM 407-x has a higher access speed from the CPU 401-x than that of the flash ROM 408-x.

The flash ROM controller 409-x, under the control of the CPU 401-x, controls the reading/writing of the data from/to the flash ROM 410-x. The flash ROM 410-x stores the data written under control of the flash ROM controller 409-x. Specific examples of the data include image data, video data, etc., acquired through the radio LAN I/F 402-x by the user using the portable terminal 201-x. For example, a memory card, an SD card, etc., can be employed as the flash ROM 410-x.

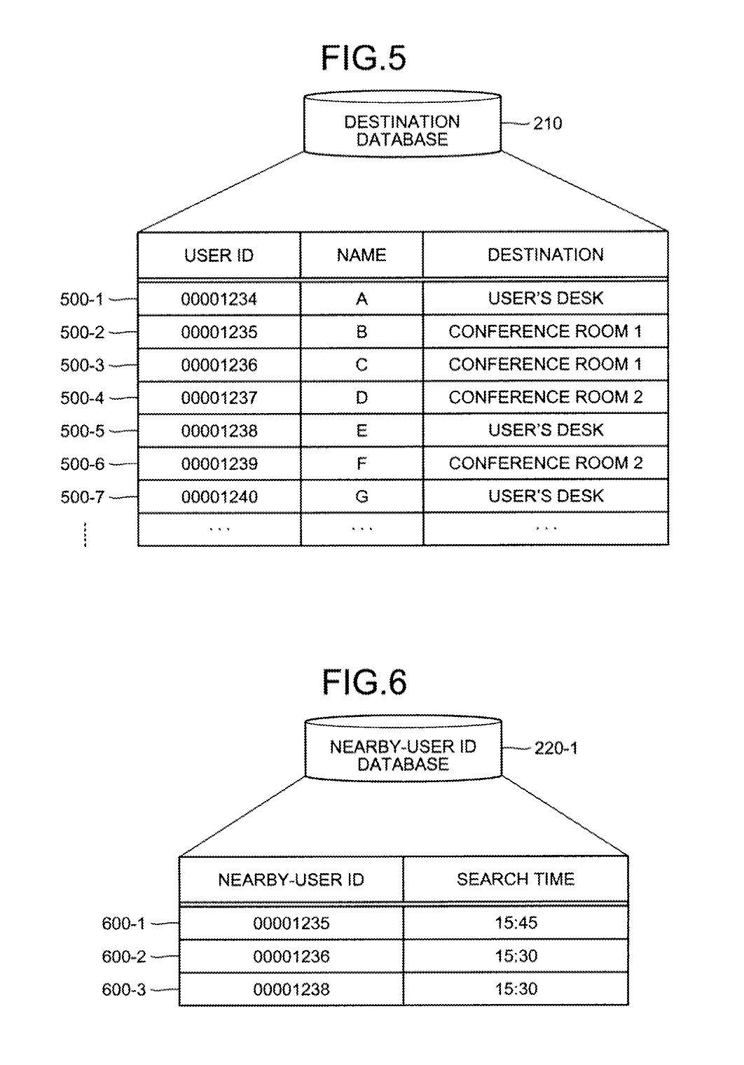

FIG. 5 is an explanatory diagram of one example of the destination database 210 according to the first embodiment. The destination database 210 has a destination record for each user. The destination database 210 has fields including user ID, name, and destination. A user ID is identification information to identify the user and is, for example, a number that differs from one user to another, such as an employee number.

A name is the name of the user identified by the user ID. While the name is not used in this destination determination processing, it is shown in the destination database 210 for easier understanding. A destination is the destination of the user identified by the user ID. For example, place names such as the user's desk, employee lounge, and the names of conference rooms can be given as the destination.

With information entered into each field, destination information (e.g., destination records 500-1 to 500-7) is stored as records. It is assumed that the destination database 210 is stored in a memory device such as the RAM 303, the magnetic disk 305, and the optical disk 307.

FIG. 6 is an explanatory diagram of one example of the nearby-user ID database 220-1 according to the first embodiment. The nearby-user ID database 220-1 has fields including a nearby-user ID and a search time. A nearby-user ID is the user ID of the user of another portable terminal within radio communication range of the portable terminal 201-1, via the Bluetooth I/F 403-1. Another portable terminal within the communication range of the portable terminal 201-1 is referred to as a nearby portable terminal. The user ID of the user of the portable terminal 201-1 is referred to as the user ID of the portable terminal 201-1.

The search time is the most recent time at which the nearby portable terminal of the portable terminal 201-1 carried by the user identified by the user ID registered in the nearby-user ID field and the portable terminal 201-1 exchanged the user ID. With information set in each field, nearby-user information (e.g., nearby-user records 600-1 to 600-3) is stored as records. It is assumed that the nearby-user ID database 220-1 is stored in a memory device such as the RAM 407-1 and the flash ROM 408-1.

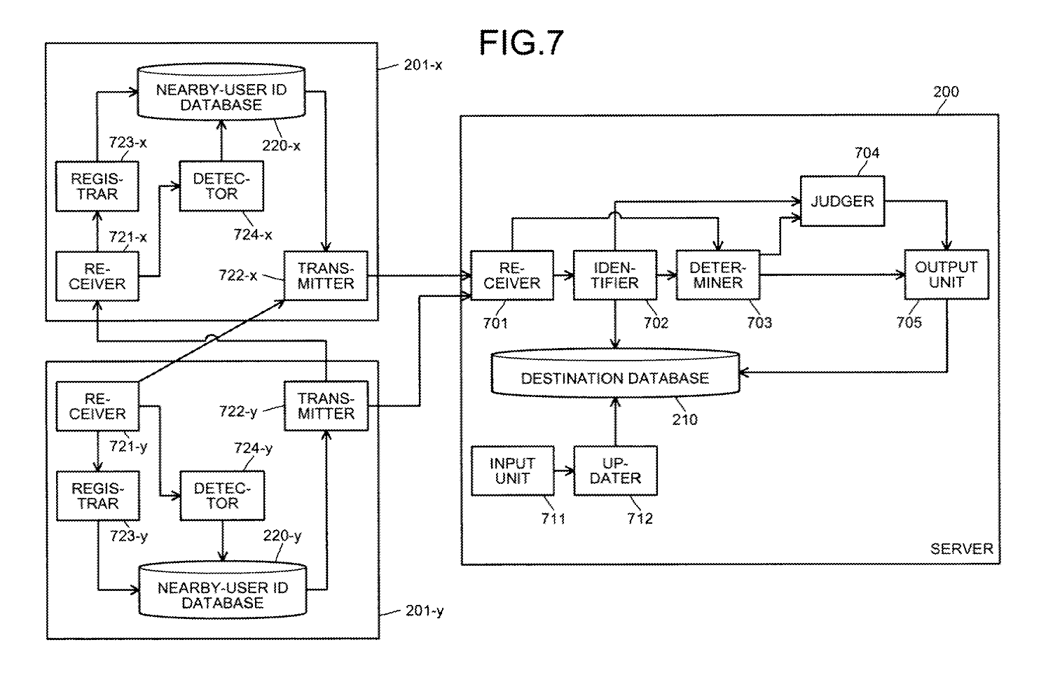

FIG. 7 is a block diagram of a function example of each of the portable terminal 201-x and the server 200 according to the first embodiment. The server 200 has a receiver 701, an identifier 702, a determiner 703, a judger 704, an output unit 705, an input unit 711, and an updater 712. The portable terminal 201-x (x=1 to i) has a receiver 721-x, a transmitter 722-x, a registrar 723-x, and a detector 724-x. The portable terminal 201-y (y=1 to i≠x) has a receiver 721-y, a transmitter 722-y, a registrar 723-y, and a detector 724-y.

Processing of the receiver 721-x to the detector 724-x is coded into a program and the program is stored in a memory device such as the ROM 406-x, the RAM 407-x, and the flash ROM 408-x. With the CPU 401-x reading out the program stored in the memory device and executing the processing coded into the program, the processing of the receiver 721-x to the detector 724-x is executed by the CPU 401-x.

Processing of the receiver 721-y to the detector 724-y is coded into a program and the program is stored in a memory device such as the ROM 406-y, the RAM 407-y, and the flash ROM 408-y. With the CPU 401-y reading out the program stored in the memory device and executing the processing coded into the program, the processing of the receiver 721-y to the detector 724-y is executed by the CPU 401-y.

Processing of the receiver 701 to the output unit 705, the input unit 711, and the updater 712 is coded into a destination determining program and the destination determining program is stored in a memory device such as the ROM 302, the RAM 303, the magnetic disk 305, and the optical disk 307. The CPU 301 reads out the destination determining program stored in the memory device and executes the processing coded into the destination determining program. Consequently, the processing of the receiver 701 to the output unit 705, the input unit 711, and the updater 712 is executed by the CPU 301. The first embodiment indicates an example of x being equal to 1.

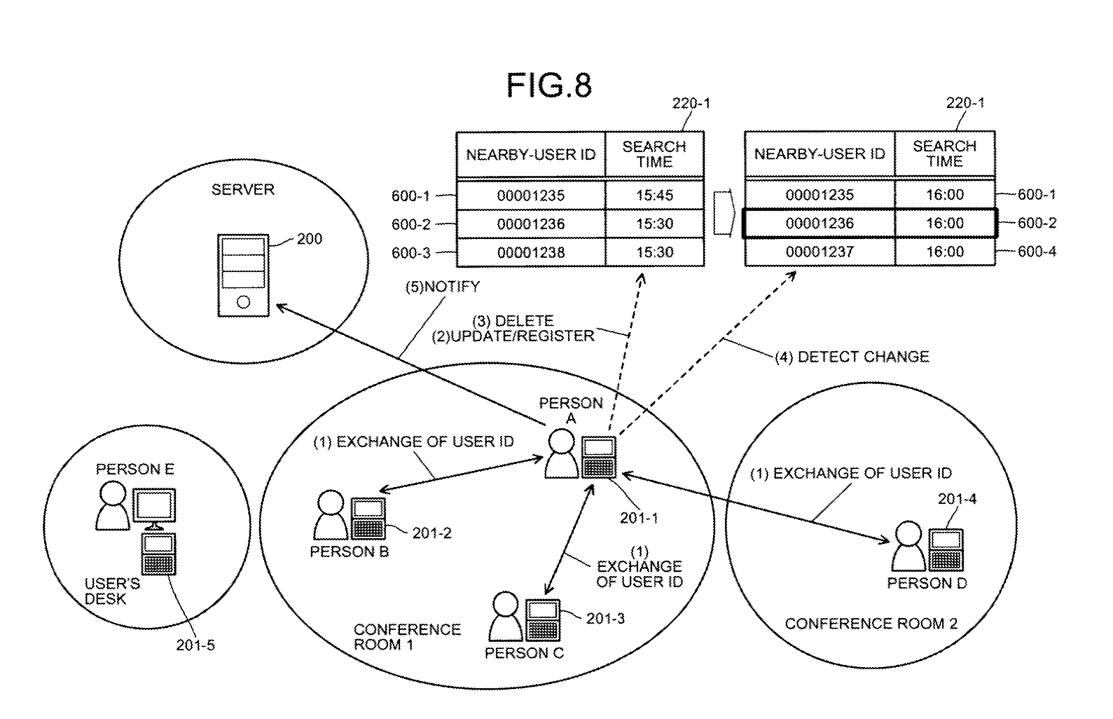

FIG. 8 is an explanatory diagram of an example of the exchange of the user ID between the portable terminal 201-1 and the nearby portable terminal according to the first embodiment. For example, the transmitter 722-1 uses the Bluetooth I/F 403-1 and notifies surrounding portable terminals of information whether communication with the portable terminal 201-1 is possible. A surrounding portable terminal is a portable terminal within communication range and capable of radio communication via the Bluetooth I/F 403-1 of the portable terminal 201-1. The receivers 721-2 to 721-4 receive from the portable terminal 201-1, information indicating whether communication is possible and the transmitters 722-2 to 722-4 transmit information indicating the ability to communicate with the portable terminal 201-1.

Upon receiving from the portable terminals 201-2 to 201-4, the information indicating the capability of communicating, the receiver 721-1 and the transmitter 722-1 (1) exchange user IDs with each of the portable terminals 201-2 to 201-4. The receiver 721-1 receives “00001235”, “00001236”, and “00001237” through the exchange of the user ID. The registrar 723-1 acquires the current time.

The registrar 723-1 refers to the nearby-user ID database 220-1 and identifies the nearby-user information that includes any one of “00001235”, “00001236”, and “00001237”. The nearby-user record 600-1 has “00001235” in the nearby-user ID field and the nearby-user record 600-2 has “00001236” in the nearby-user ID field. The registrar 723-1 (2) updates the time in the search time field of the nearby-user record 600-1 and the time in the search time field of the nearby-user record 600-2 to the current time. It is assumed that the current time is 16:00.

Since nearby-user information that includes “00001237” is not identified in nearby-user ID database 220-1, the registrar 723-1 (2) registers “00001237” at the nearby-user ID field of the nearby-user ID database 220-1. The registrar 723-1 sets the current time to the search time field of the nearby-user ID database 220-1, preparing a new nearby-user record 600-4.

The registrar 723-1 refers to the nearby-user ID database 220-1 and identifies nearby-user information that includes a user ID other than the exchanged user IDs. For example, the nearby-user record 600-3 is identified that has “00001238” registered in the nearby-user ID field.

The registrar 723-1 judges whether the time from the time registered in the search time field of the identified nearby-user record 600-3 until the current time is longer than a predetermined period. For example, the predetermined period is given as 15 [minutes]. The above time is 30 [minutes] and therefore, is judged to be longer than the predetermined period. The registrar 723-1 (3) deletes the nearby-user record 600-3 from the nearby-user ID database 220-1. Though not depicted, if the above time is judged to not be longer than the predetermined period, the registrar 723-1 (3) does not delete the nearby-user record 600-3 from the nearby-user ID database 220-1.

The transmitter 722-1 (4) detects a change in the nearby-user ID database 220-1. The transmitter 722-1 (5) transmits to the server 200 by way of the network 314, notification information having the user IDs that are registered in the nearby-user ID field of the nearby-user ID database 220-1 and the user ID of the user of the portable terminal 201-1.

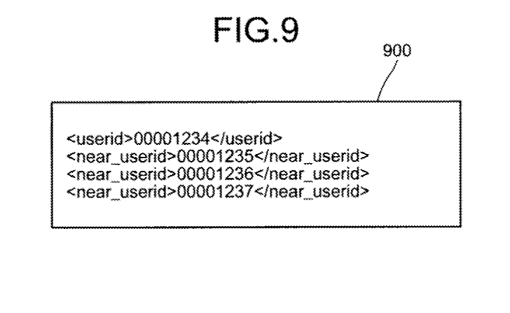

FIG. 9 is an explanatory diagram of an example of the notification information according to the first embodiment. The notification information 900 is an Extensible Markup Language (XML) document. The notification information 900 describes, between a <userid> tag and a </userid> tag, the user ID of the user of the portable terminal 201-1 that is the originator of the notification information 900.

The notification information 900 describes the user ID of the user of one nearby portable terminal within the communication range of the portable terminal 201-1 as the originator of the notification between a <near_userid> tag and a </near_userid> tag. That is to say, the notification information 900 indicates that the user ID of the user of the portable terminal 201-1 that is the originator of the notification is “00001234”. The notification information 900 indicates that the user IDs of the users of the nearby portable terminals within the communication range of the portable terminal 201-1 that is the originator of the notification are “00001235”, “00001236”, and “00001237”.

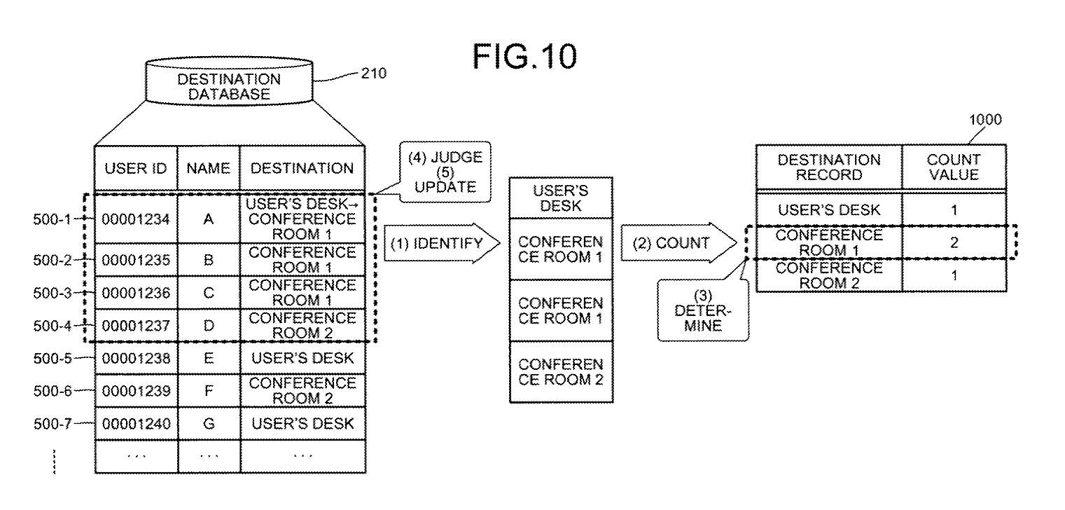

FIG. 10 is an explanatory diagram of an example of the destination determination concerning the user of the portable terminal 201-1 according to the first embodiment. For example, the receiver 701, upon receiving a connection from the portable terminal, receives the notification information 900 from the portable terminal 201-1. The receiver 701 recognizes the number described between the <userid> tag and the </userid> tag included in the notification information 900 as the user ID of the user of the portable terminal 201-1. The receiver 701 recognizes the number described between the <near_userid> tag and the </near_userid> tag included in the notification information 900 as the user ID of the nearby portable terminal within the communication range of the portable terminal 201-1.

Then, the identifier 702 identifies the destination associated with the user ID of the user of the portable terminal 201-1 from the destination database 210. The identifier 702 identifies the destinations associated with the user IDs of the users of the portable terminals 201-2 to 201-4 from the destination database 210.

For example, the identifier 702 refers to the destination database 210 and searches for the destination record having “00001234” registered in the user ID field. The destination record 500-1 is retrieved. For example, the identifier 702 extracts the destination registered in the destination field of the retrieved destination record 500-1, consequently (1) the destination of the user of the portable terminal 201-1 is identified from the destination record 500-1. That is to say, the destination of the user of the portable terminal 201-1 is “user's desk”.

For example, the identifier 702 refers to the destination database 210 and searches for the destination record having “00001235”, “00001236”, or “00001237” registered in the user ID field. The destination record 501-2, the destination record 501-3, and the destination record 501-4 are retrieved. For example, the identifier 702 extracts the destination registered in the destination field of each of the retrieved destination records 500-2 to 500-4.

Consequently, (1) the destination of each of the users of the portable terminals 201-2 to 201-4 within the communication range of the portable terminal 201-1 is identified. That is to say, the destination of the user of the portable terminal 201-2 is “conference room 1” and the destination of the user of the portable terminal 201-3 is “conference room 1”. The destination of the user of the portable terminal 201-4 is “conference room 2”.

The determiner 703 determines the destination of the highest count, among the destinations of the destination record identified by the identifier 702, as the destination of the user of the portable terminal 201-1. For example, the determiner 703 selects an unselected destination among the identified destinations and judges whether the selected destination is registered in a table 1000. For example, (2) if the selected destination is registered in the table 1000, the determiner 703 increments the count value corresponding to the selected destination. Further, (2) if the selected destination is not registered in the table 1000, the determiner 703 registers the selected destination into the table 1000 and sets the count value to 1.

In the table 1000, the count value of “user's desk” is 1, the count value of “conference room 1” is 2, and the count value of “conference room 2” is 1. For example, the determiner 703 (3) determines “conference room 1” of the highest count as the destination of the user of the portable terminal 201-1.

For example, the judger 704 (4) judges whether the destination in the destination record 500-1 identified by the identifier 702 and the destination of the user of the portable terminal 201-1 determined by the determiner 703 coincide. The determined destination of the user of the portable terminal 201-1 is “conference room 1”, while the destination in the destination record 500-1 is “user's desk”. Therefore, it is judged that the determined destination of the user of the portable terminal 201-1 and the destination in the destination record 500-1 do not coincide.

The output unit 705 outputs results of the determination by the determiner 703 in association with the user ID of the user of the portable terminal 201-1. For example, the output unit 705 (5) updates the destination in the destination record 500-1 stored in the destination database 210 to “conference room 1”.

When the determined destination of the user of the portable terminal 201-1 and the identified destination in the destination record 500-1 do not coincide, the destination database 210 is updated. The method is not limited hereto and for example, information indicating that the destinations do not coincide may be associated with the destination record 500-1 of the destination database 210. For example, when any portable terminal refers to the destination in the destination record 500-1 in the destination database 210, the information indicating that the destinations do not coincide may be acquired in association with the destination.

The input unit 711 receives an updating instruction that includes identification information of the user and the destination of the user by the user input operation. The updating instruction received by user input operation is transmitted to the server 200 from the portable terminal 201-i (i≧1) carried by the user, the PC possessed by the user, etc. For example, if person A is taken as the user, person A uses the keyboard 405-1 of the portable terminal 201-1 that person A carries and inputs an updating instruction to the portable terminal 201-1, whereby the input unit 711 receives the updating instruction from the portable terminal 201-1 by way of the network 314. For example, configuration may be such that the user uses the keyboard of his PC to input the updating instruction, whereby the input unit 711 receives the updating instruction from the PC.

For example, configuration may be such that the user uses the mouse 311 or the keyboard 310 of the server 200 to input the updating instruction to the server 200, whereby the input unit 711 receives the updating instruction. The updater 712 refers to the destination database 210 and updates to the destination of the user included in the updating instruction, the destination in the destination record that includes the user ID of the user included in the updating instruction.

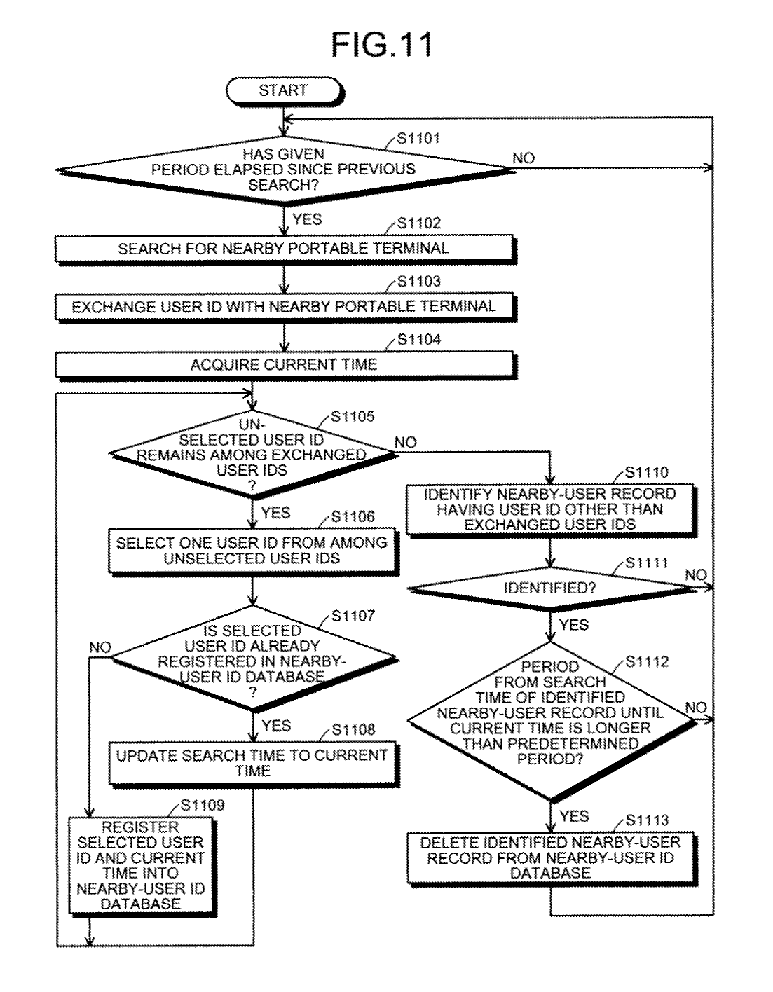

FIG. 11 is a flowchart of one example of the user ID exchange by the portable terminal 201-x according to the first embodiment. Firstly, the portable terminal 201-x judges whether a given period has elapsed since the previous search (step S1101). If the portable terminal 201-x judges that the given period has not elapsed since the previous search (step S1101: NO), the flow returns to step S1101. If the portable terminal 201-x judges that the given period has elapsed since the previous search (step S1101: YES), the portable terminal 201-x searches for nearby portable terminals (step S1102). A nearby portable terminal is a portable terminal that is within communication range of the portable terminal 201-x.

The portable terminal 201-x exchanges the user ID with the portable terminals (step S1103), acquires the current time (step S1104), and judges whether any unselected user ID remains among the exchanged user IDs (step S1105). If the portable terminal 201-x judges that an unselected user ID remains among the exchanged user IDs (step S1105: YES), the portable terminal 201-x selects one user ID from among the unselected user IDs (step S1106).

The portable terminal 201-x judges whether the selected user ID is already registered in the nearby-user ID database 220-x (step S1107). If the portable terminal 201-x judges that the selected user ID is already registered in the nearby-user ID database 220-x (step S1107: YES), the portable terminal 220-x updates the search time of the nearby-user record having the selected user ID in the nearby-user ID database 220-x to the current time (step S1108) and returns to step S1105.

If the portable terminal 201-x judges that the selected user ID is not registered in the nearby-user ID database 220-x (step S1107: NO), the portable terminal 201-x newly prepares a nearby-user record by registering the selected user ID and the current time into the nearby-user ID database 220-x (step S1109) and returns to step S1105.

If the portable terminal 201-x judges that there is no unselected user ID among the exchanged user IDs (step S1105: NO), the portable terminal 201-x refers to the nearby-user ID database 220-x, and identifies a nearby-user record having a user ID other than the exchanged user IDs (step S1110). The portable terminal 201-x judges whether a nearby-user record having a user ID other than the exchanged user IDs has been identified (step S1111).

If the portable terminal 201-x judges that a nearby-user record having a user ID other than the exchanged user IDs has been identified (step S1111: YES), the flow proceeds to step S1112. The portable terminal 201-x judges whether the period from the search time of the identified nearby-user record until the current time is longer than a predetermined period (step S1112).

If the portable terminal 201-x judges that the time from the search time of the identified nearby-user record until the current time is longer than the predetermined period (step S1112: YES), the portable terminal 201-x deletes the identified nearby-user record from the nearby-user ID database 220-x (step S1113) and returns to step S1101.

At step S1111, if the portable terminal 201-x judges that a nearby-user record having a user ID other than the exchanged user IDs has not been identified (step S1111: NO), the flow returns to step S1101. At step S1112, if the portable terminal 201-x judges that the period from the search time of the identified nearby-user record until the current time is not longer than the predetermined period (step S1112: NO), the flow returns to step S1101.

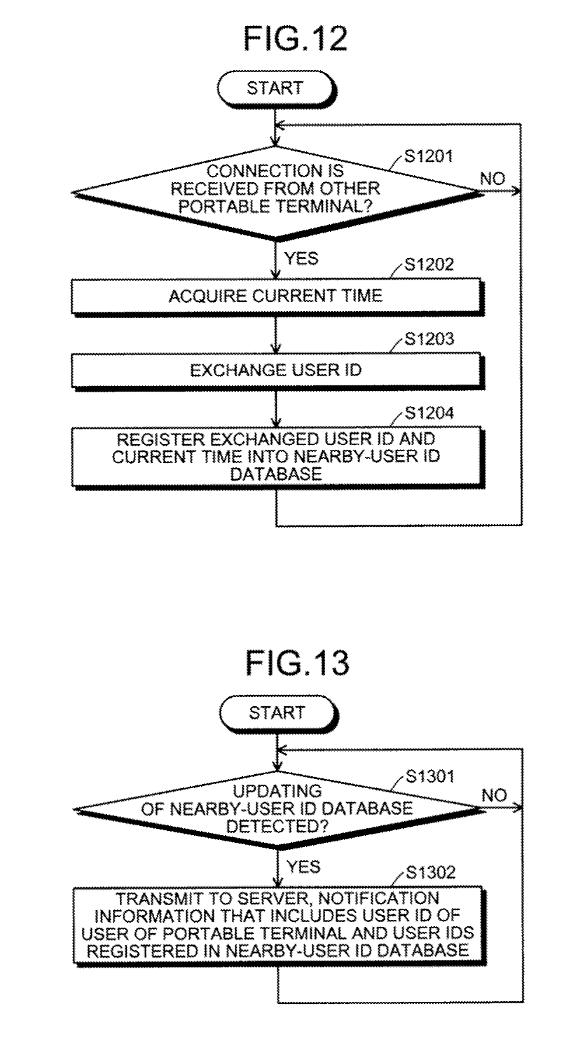

FIG. 12 is a flowchart of one example of processing of the user ID exchange by the portable terminal 201-y according to the first embodiment. The user ID exchange processing will now be described of a portable terminal 201-y within the communication range of the portable terminal 201-x when the portable terminal 201-x has started the user ID exchange processing. The portable terminal 201-y, by the receiver 721-y, judges whether a connection from a portable terminal has been received (step S1201). If the portable terminal 201-y judges that a connection from a portable terminal 201-y has not been received (step S1201: NO), the flow returns to step S1201.

If the portable terminal 201-y judges that a connection from a portable terminal has been received (step S1201: YES), the portable terminal 201-y acquires the current time (step S1202) and, by the transmitter 722-y and the receiver 721-y, exchanges the user ID with the portable terminal, which is the originator of the connection (step S1203). The portable terminal 201-y, by the registrar 723-y, registers the exchanged user ID and the current time into the nearby-user ID database 220-y, thereby newly preparing a nearby-user record (step 1204). The flow returns to step S1201.

FIG. 13 is a flowchart of one example of the transmission of notification information by the portable terminal 201-x according to the first embodiment. The portable terminal 201-x judges whether updating of the nearby-user ID database 220-x has been detected (step 1301). If the portable terminal 201-x judges that updating of the nearby-user ID database 220-x has not been detected (step 1301: NO), the flow returns to step S1301.

If the portable terminal 201-x judges that updating of the nearby-user ID database 220-x has been detected (step 1301: YES), the portable terminal 201-x transmits to the server 200, the notification information 900 that includes the user ID of the user of the portable terminal 201-x and the user IDs registered in the nearby-user ID database 220-x (step S1302) and returns to step S1301.

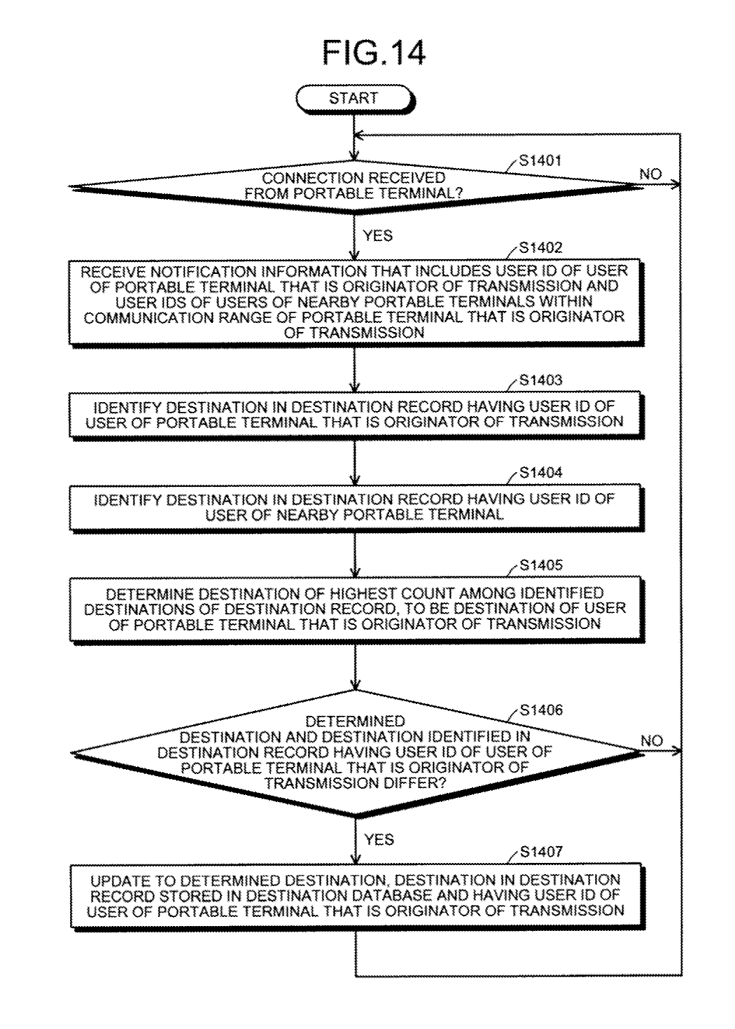

FIG. 14 is a flowchart of one example of the destination determination by the server 200 according to the first embodiment. The server 200 firstly judges whether a connection from a portable terminal has been received (step S1401). If the server 200 judges that a connection from a portable terminal has not been received (step S1401: NO), the flow returns to step s1401. If the server 200 judges that a connection from a portable terminal has been received (step S1401: YES), the server 200 receives from the portable terminal, the notification information 900 that includes the user ID of the user of the portable terminal, which is the originator of the transmission, and the user IDs of the users of nearby portable terminals within communication range of the portable terminal that is the originator of the transmission (step S1402).

Server 200 then identifies the destination in the destination record having the user ID of the user of the portable terminal that is the originator of the transmission (step S1403) and identifies the destinations in the destination records having the user IDs of the users of nearby portable terminals (step S1404). The server 200 determines the destination of the highest count, among the identified destinations, as the destination of the user of the portable terminal that is the originator of the transmission (step S1405).

The server 200 judges whether the determined destination and the destination identified in the destination record having the user ID of the user of the portable terminal that is the originator of the transmission differ (step S1406). If the server 200 judges that the destination identified in the destination record having the user ID of the user of the portable terminal that is the originator of the transmission and the determined destination differ (step S1406: YES), the flow proceeds to step S1407. The server 200 updates to the determined destination, the destination in the destination record that is stored in the destination database 210 and has the user ID of the user of the portable terminal that is the originator of the transmission (step S1407); and returns to step S1401. If the server 200 judges that the identified destination in the destination record having the user ID of the user of the portable terminal that is the originator of the transmission and the determined destination coincide (step S1406: NO), the flow returns to step S1401.

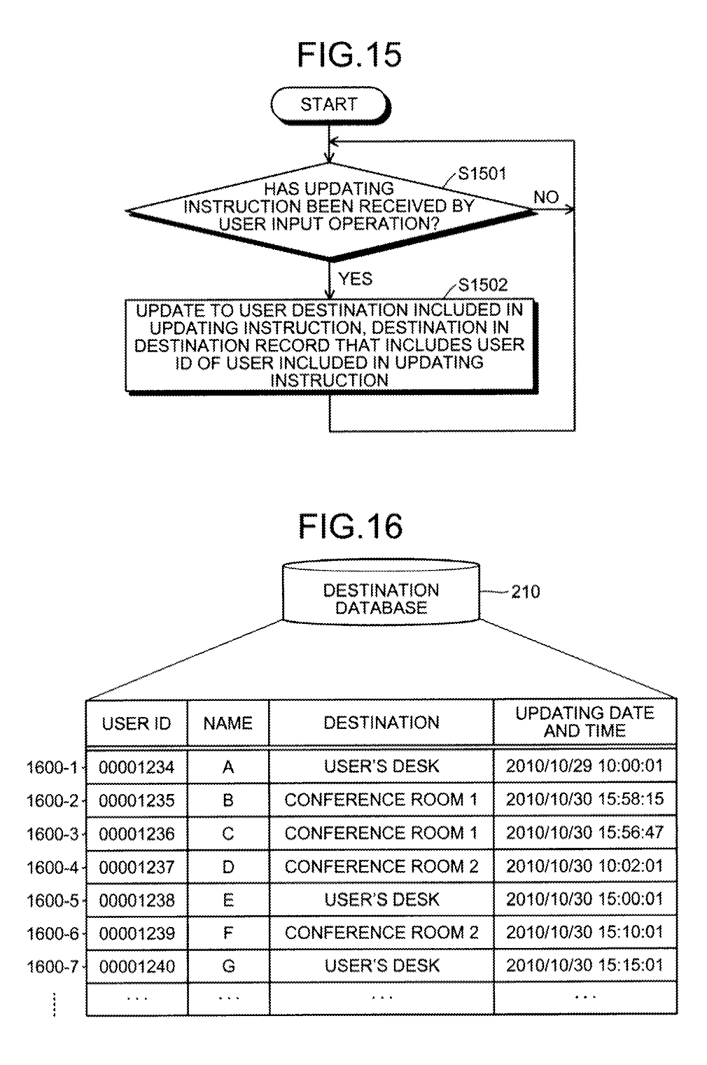

FIG. 15 is a flowchart of the updating processing by the server 200 according to the first embodiment. The server 200 firstly judges whether the updating instruction by a user input operation has been received (step S1501) and if it is judged that an updating instruction by a user input operation has not been received (step S1501: NO), the flow returns to step S1501.

If the server 200 judges that an updating instruction by a user input operation has been received (step S1501: YES), the server 200 refers to the destination database 210 and updates to the destination of the user included in the updating instruction, the destination in the destination record that includes the user ID of the user included in the updating instruction (step S1502). After step S1502, the server 200 returns to step S1501.

The second embodiment indicates an example of determining, as the destination of a given user, the destination of the most recent updating date and time, among the destination of the given user and the destinations of other users within a short distance from the given user. In the second embodiment, functions and information similar to that in the first embodiment are given same reference numerals used in the first embodiment and the description thereof is omitted.

FIG. 16 is an explanatory diagram of one example of the destination database 210 according to the second embodiment. The destination database 210 has a destination record for each user. The destination database 210 has fields including user ID, name, destination, and updating date and time. A user ID is identification information to identify the user and is, for example, a number that differs from one user to another, such as an employee number.

A name is the name of the user identified by the user ID. While the name is not used in this destination determination processing, it is shown in the destination database 210 for easier understanding. A destination is the destination of the user identified by the user ID. For example, place names such as the user's desk, employee lounge, and the names of conference rooms can be given as the destination. The updating date and time is the date and time at which the user identified by the user ID updated the destination.

With information entered into each field, destination information (e.g., destination records 1600-1 to 1600-7) is stored as records. It is assumed that the destination database 210 is stored in a memory device such as the RAM 303, the magnetic disk 305, and the optical disk 307.

Since the processing of exchanging the user ID by the portable terminal 201-x is the same as the processing of exchanging the user ID by the portable terminal 201-x that was described in the first embodiment, the description thereof is omitted here.

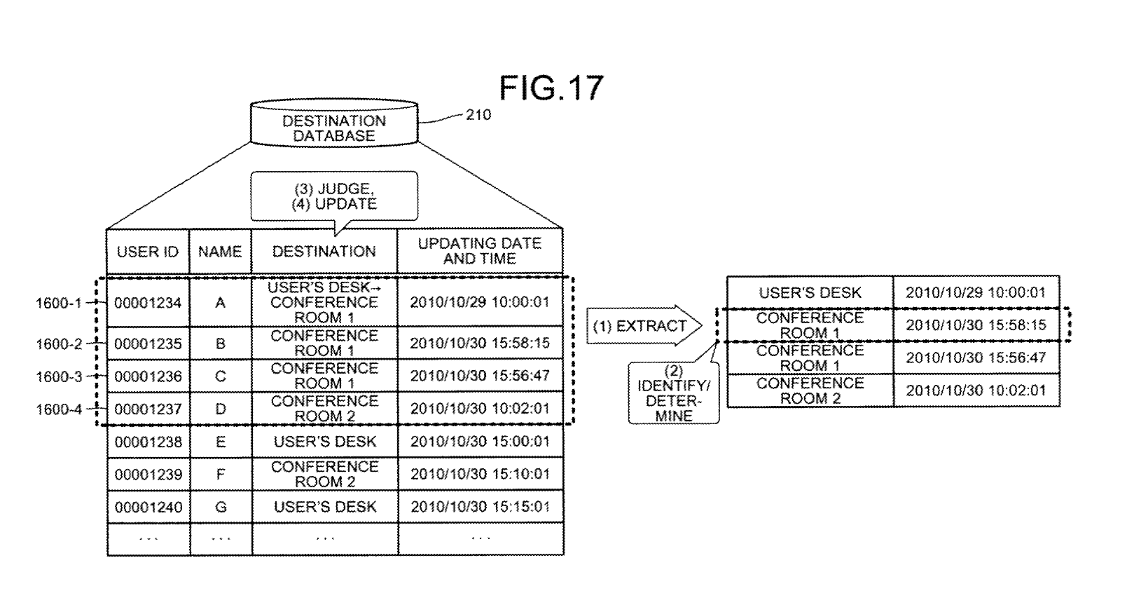

FIG. 17 is an explanatory diagram of an example of the destination determination concerning the user of the portable terminal 201-1 according to the second embodiment. For example, the receiver 701, upon receiving a connection from the portable terminal 201-1, receives the notification information 900 from the portable terminal 201-1. The receiver 701 recognizes the number described between the <userid> tag and the </userid> tag included in the notification information 900 as the user ID of the user of the portable terminal 201-1. The receiver 701 recognizes the number described between the <near_userid> tag and the </near_userid> tag included in the notification information 900 as the user ID of the nearby portable terminal within the communication range of the portable terminal 201-1.

The identifier 702 then identifies the destination of the most recent updating date and time among the destinations of the users of the nearby portable terminals and the destination of the user of the portable terminal 201-1.

For example, the identifier 702 refers to the destination database 210 and searches for a destination record having “00001234” registered in the user ID field. The destination record 1600-1 is retrieved. For example, the identifier 702 extracts the destination registered in the destination field, and the date and time registered in an updating date and time field, of the retrieved destination record 1600-1.

The identifier 702 refers to the destination database 210 and searches for a destination record having “00001235”, “00001236”, or “00001237” registered in the user ID field. The destination record 1600-2, the destination record 1600-3, and the destination record 1600-4 are retrieved. For example, the identifier 702 extracts the destination registered in the destination field and the date and time registered in the updating date and time field of each of the retrieved destination records 1600-2 to 1600-4.

For example, the identifier 702 (2) identifies the destination of the most recent updating date and time, among the extracted destinations. “Conference room 1” is identified.

The determiner 703 determines the destination of the most recent updating date and time identified by the identifier 702 as the destination of the user of the portable terminal 201-1. For example, the determiner 703 (2) determines “conference room 1” as the destination of the user of the portable terminal 201-1.

For example, the judger 704 (3) judges whether the destination in the retrieved destination record 1600-1 and the destination of the user of the portable terminal 201-1 determined by the determiner 703 coincide. The determined destination of the user of the portable terminal 201-1 is “conference room 1”, while the destination in the destination record 1600-1 is “user's desk”. Therefore, the judger 704 judges that the determined destination of the user of the portable terminal 201-1 and the destination in the destination record 1600-1 do not coincide.

For example, the output unit 705 (4) updates the destination in the destination record 1600-1 stored in the destination database 210 to “conference room 1”.

The input unit 711 receives an updating instruction by a user input operation. The updating instruction by a user input operation may be transmitted to the server 200 from the portable terminal 201-i (i≧1) carried by the user, the PC possessed by the user, etc. The updating instruction may be input by the user directly to the server 200 using the mouse 311 or the keyboard 310 thereof. The updater 712 updates to the destination of the user included in the updating instruction, the destination in the destination record that includes the user ID of the user included in the updating instruction. The updater 712 acquires the current time and updates the updating date and time in the destination record to the current time.

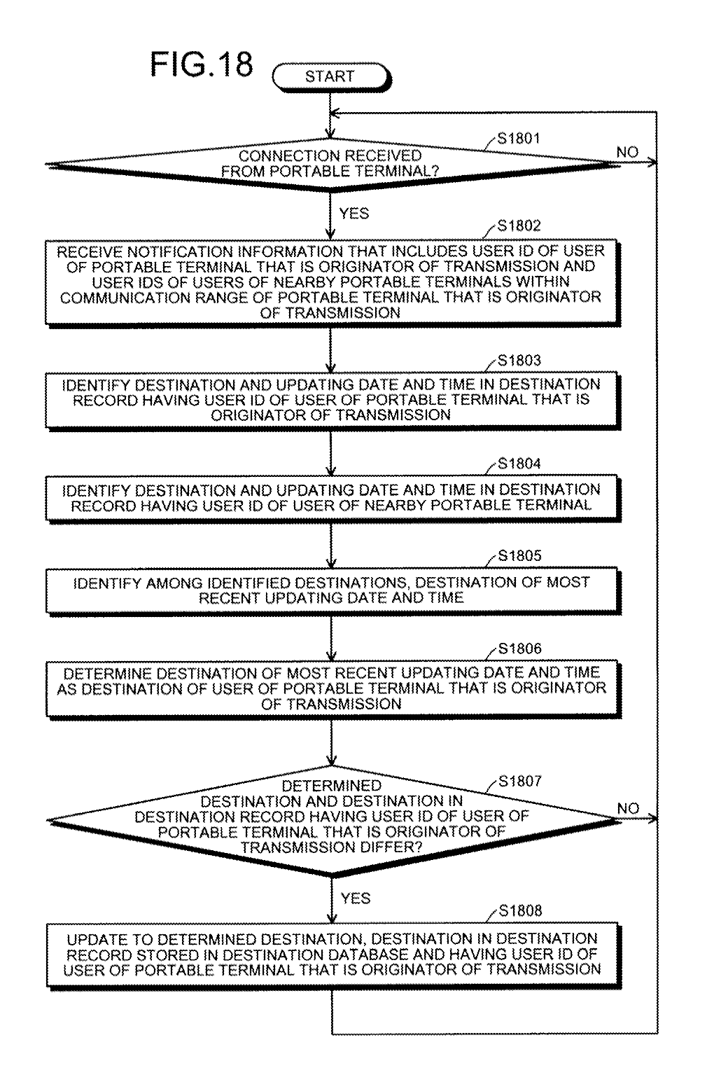

FIG. 18 is a flowchart of one example of the destination determination by the server 200 according to the second embodiment. The server 200 firstly judges whether a connection from a portable terminal has been received (step S1801). If the server 200 judges that a connection from a portable terminal has not been received (step S1801: NO), the flow returns to step S1801. If the server 200 judges that a connection from a portable terminal has been received (step S1801: YES), the server 200 receives the notification information that includes the user ID of the user of the portable terminal, which is the originator of the transmission, and the user IDs of the users of nearby portable terminals within communication range of the portable terminal that is the originator of the transmission (step S1802).

The server 200 then identifies the destination and the updating date and time in the destination record having the user ID of the user of the portable terminal that is the originator of the transmission (step S1803). The server 200 identifies the destinations and the updating dates and times of the destination record having the user IDs of the users of the nearby portable terminals (step S1804).

The server 200 identifies the destination of the most recent updating date and time among the identified destinations (step S1805). The server 200 determines the destination of the most recent updating date and time as the destination of the user of the portable terminal that is the originator of the transmission (step S1806) and judges whether the destination in the destination record having the user ID of the user of the portable terminal that is the originator of the transmission and the determined destination differ (step S1807).

If the server 200 judges that the destination in the destination record having the user ID of the user of the portable terminal that is the originator of the transmission and the determined destination differ (step S1807: YES), the flow proceeds to step S1808. The server 200 updates to the determined destination, the destination in the destination record having the user ID of the user of the portable terminal that is the originator of the transmission that is stored in the destination database 210 (step S1808) and returns to step S1801.

If the server 200 judges that the destination in the destination record having the user ID of the user of the portable terminal that is the originator of the transmission and the determined destination coincide (step S1807: NO), the flow returns to step S1801.

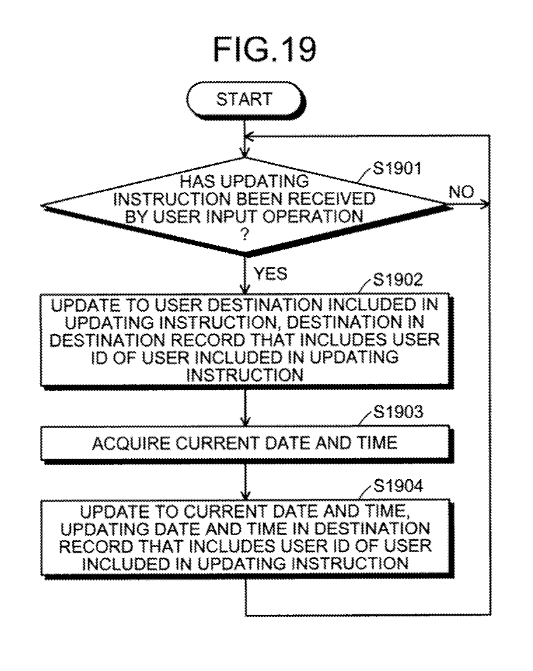

FIG. 19 is a flowchart of the updating processing by the server 200 according to the second embodiment. The server 200 firstly judges whether the updating instruction by a user input operation has been received (step S1901) and if it is judged that an updating instruction by a user input operation has not been received (step S1901: NO), the flow returns to step S1901.

If the server judges that the updating instruction by the user input operation has been received (step S1901: YES), the server 200 updates to the user destination included in the updating instruction, the destination in the destination record that includes the user ID of the user included in the updating instruction (step S1902). The server 200 acquires the current date and time (step 1903), updates the updating date and time in the destination record that includes the user ID of the user included in the updating instruction to the acquired current date and time (step S1904), and returns to step S1901.

The third embodiment indicates an example of determining as the destination of a given user the destination of the user having the largest number of updates among the number of times the given user updated the destination and the number of times other users within a short distance from the given user updated the destination.

In the third embodiment, functions and information similar to that in the first and second embodiments are given same reference numerals used in the first and second embodiments and the description thereof is omitted.

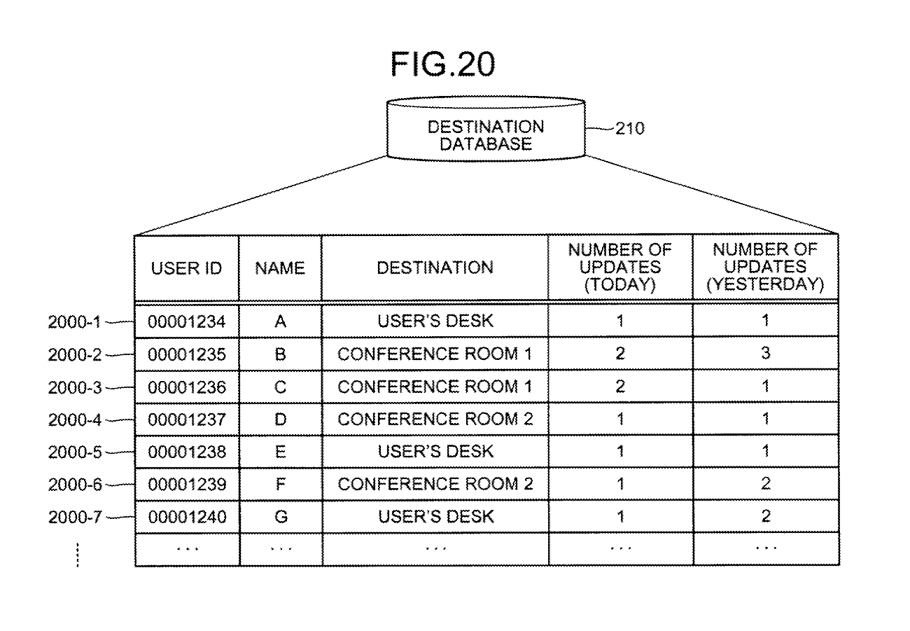

FIG. 20 is an explanatory diagram of one example of the destination database 210 according to the third embodiment. The destination database 210 has a destination record for each user. The destination database 210 has fields including user ID, name, destination, the number of updates (today), and the number of updates (yesterday). A user ID is identification information to identify the user and is, for example, a number that differs from one user to another, such as an employee number.

A name is the name of the user identified by the user ID. While the name is not used in this destination determination processing, it is shown in the destination database 210 for easier understanding. A destination is the destination of the user identified by the user ID. For example, place names such as the user's desk, employee lounge, and the names of conference rooms can be given as the destination. The number of updates (today) is the number of times today the user identified by the user ID updated the destination. The number of updates (yesterday) is the number of times yesterday the user identified by the user ID updated the destination.

With information entered into each field, destination information (e.g., destination records 2000-1 to 2000-7) is stored as records. It is assumed that the destination database 210 is stored in a memory device such as the RAM 303, the magnetic disk 305, and the optical disk 307.

Since the processing of exchanging the user ID by the portable terminal 201-1 is the same as the processing of exchanging the user ID by the portable terminal 201-x that was described in the first embodiment, detailed description thereof is omitted here.

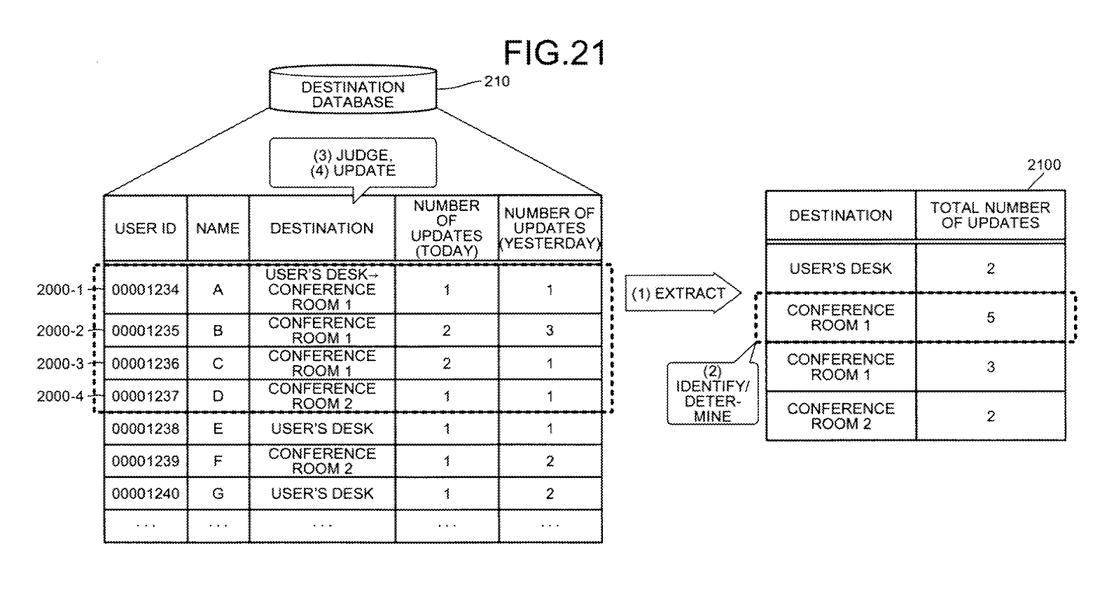

FIG. 21 is an explanatory diagram of an example of the destination determination concerning the user of the portable terminal 201-1 according to the third embodiment. For example, the receiver 701, upon receiving a connection from the portable terminal, receives the notification information 900 from the portable terminal 201-1. The receiver 701 recognizes the number described between the <userid> tag and the </userid> tag included in the notification information 900 as the user ID of the user of the portable terminal 201-1. The receiver 701 recognizes the number described between the <near_userid> tag and the </near_userid> tag included in the notification information 900 as the user ID of the nearby portable terminal within the communication range of the portable terminal 201-1.

Then, the identifier 702 refers to the destination database 210 and identifies the destination of the user having the largest number of updates among the user of the portable terminal 201-1 and the users of the nearby portable terminals within the communication range of the portable terminal 201-1.

For example, the identifier 702 refers to the destination database 210 and searches for the destination record having “00001234” registered in the user ID field. The destination record 2000-1 is retrieved. For example, the identifier 702 (1) extracts the destination registered in the destination field, the number of updates (today) registered in the number of updates (today) field, and the number of updates (yesterday) registered in the number of updates (yesterday) field, of the retrieved destination record 2000-1.

For example, the identifier 702 refers to the destination database 210 and searches for the destination record having “00001235”, “00001236”, or “00001237” registered in the user ID field. The destination record 2000-2, the destination record 2000-3, and the destination record 2000-4 are retrieved.

For example, the identifier 702 (1) extracts the destination registered in the destination field of each of the retrieved destination records 2000-2 to 2000-4. For example, the identifier 702 (1) extracts the number of updates (today) registered in the number of updates (today) field of each of the retrieved destination records 2000-2 to 2000-4. For example, the identifier 702 (1) extracts the number of updates (yesterday) registered in the number of updates (yesterday) field of each of the retrieved destination records 2000-2 to 2000-4.

For example, the identifier 702 (2) sums the retrieved number of updates (today) and number of updates (yesterday) for each of the users. The identifier 702 identifies the destination of the user having the largest calculated sum. In a table 2100, the destination of the user having the largest number of updates is “conference room 1”.

The determiner 703 determines the destination of the user having the largest number of updates identified by the identifier 702 as the destination of the user of the portable terminal 201-1. For example, the determiner 703 (2) determines “conference room 1” as the destination of the user of the portable terminal 201-1.

For example, the judger 704 (3) judges whether the destination in the retrieved destination record 2000-1 and the destination of the user of the portable terminal 201-1 determined by the determiner 703 coincide. The determined destination of the user of the portable terminal 201-1 is “conference room 1”, while the destination in the destination record 2000-1 is “user's desk”. Therefore, the judger 704 judges that the determined destination of the user of the portable terminal 201-1 and the destination in the destination record 2000-1 do not coincide.

For example, the output unit 705 (4) updates the destination in the destination record 2000-1 stored in the destination database 210 to “conference room 1”.

The input unit 711 receives an updating instruction by a user input operation. The updating instruction received by the user input operation is transmitted to the server 200 from the portable terminal 201-i (i≧1) carried by the user, the PC possessed by the user, etc. The updater 712 updates to the destination of the user included in the updating instruction, the destination in the destination record that includes the user ID of the user included in the updating instruction. The updater 712 increments the number of updates (today) in the destination record that includes the user ID of the user included in the updating instruction.

The input unit 711 receives the updating of the date. For example, it is so arranged beforehand that when the date changes by means of a calendar function, etc., of the server 200, the updating of the date will be input to the input unit 711. The updater 712 updates the number of updates (today) of the destination record to the number of updates (yesterday) in each destination record. The updater 712 sets the number of updates (today) to 0 in each destination record.

The third embodiment has described an example of using the number of updates (today) and the number of updates (yesterday), however, configuration is not limited hereto. For example, configuration may be such that the number of times the user updates the destination is counted for one year and the number of updates for one year is used. Consequently, trends of the updating frequency of each user can be identified.

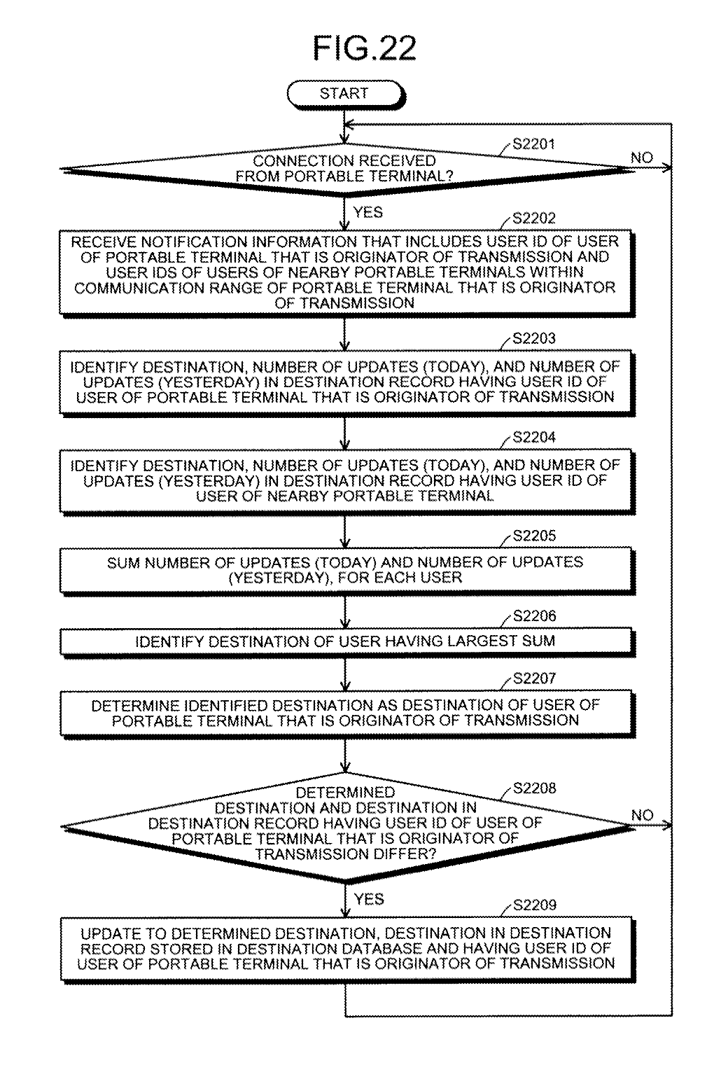

FIG. 22 is a flowchart of one example of the destination determination by the server 200 according to the third embodiment. The server 200 firstly judges whether a connection from a portable terminal has been received (step S2201). If the server 200 judges that a connection from a portable terminal has not been received (step S2201: NO), the flow returns to step S2201. If the server 200 judges that a connection from a portable terminal has been received (step S2201: YES), the server 200 receives the notification information that includes the user ID of the user of the portable terminal, which is the originator of the transmission, and the user IDs of the users of nearby portable terminals within communication range of the portable terminal that is the originator of the transmission (step S2202).

The server 200 identifies the destination, the number of updates (today), and the number of updates (yesterday), in the destination record having the user ID of the user of the portable terminal that is the originator of the transmission (step S2203). The server 200 then identifies the destination, the number of updates (today), and the number of updates (yesterday), in the destination record having the user ID of the user of the nearby portable terminal (step S2204). For each of the users, the server 200 sums the number of updates (today) and the number of updates (yesterday) (step S2205) and identifies the destination of the user having the largest number of updates (step S2206). The server 200 determines the identified destination as the destination of the user of the portable terminal that is the originator of the transmission (step S2207). The server 200 judges whether the destination in the destination record having the user ID of the user of the portable terminal that is the originator of the transmission and the determined destination differ (step S2208).

If the server 200 judges that the destination in the destination record having the user ID of the user of the portable terminal that is the originator of the transmission and the determined destination differ (step S2208: YES), the flow proceeds to step S2209. The server 200 updates to the determined destination, the destination in the destination record having the user ID of the user of the portable terminal that is the originator of the transmission that is stored in the destination database 210 (step S2209) and returns to step S2201.

If the server 200 judges that the destination in the destination record having the user ID of the user of the portable terminal that is the originator of the transmission and the determined destination coincide (step S2208: NO), the flow returns to step S2201.

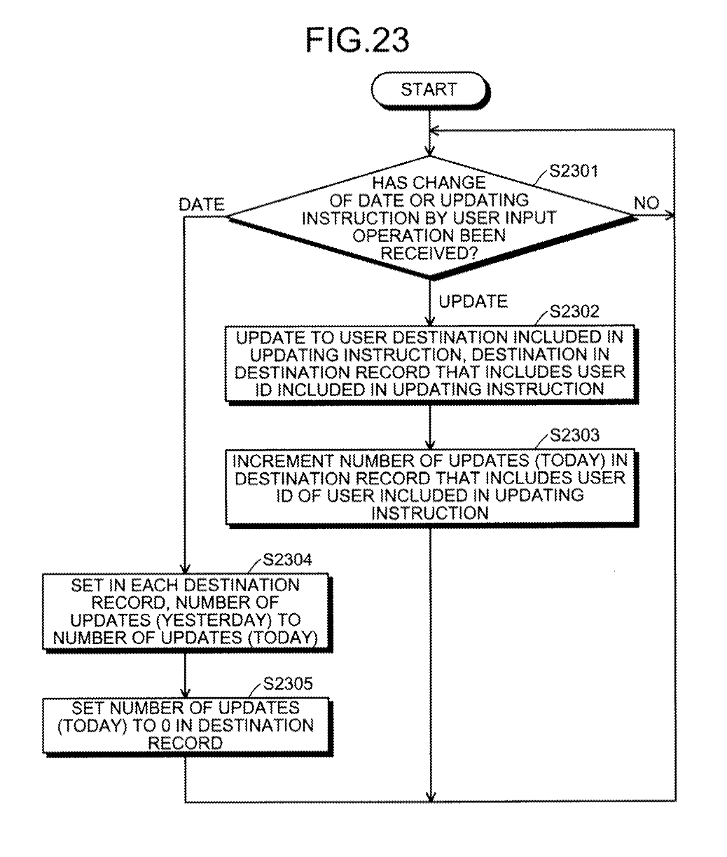

FIG. 23 is a flowchart of the updating processing by the server 200 according to the third embodiment. The server 200 judges whether an updating instruction by a user input operation or a change of the date has been received (step S2301). If it is judged that neither an updating instruction by a user input operation nor a change of the date has been received (step S2301: NO), the flow returns to step S2301.

If the server 200 judges that an updating instruction by a user input operation has been received (step S2301: UPDATE), the server 200 refers to the destination database 210 and updates to the user destination included in the updating instruction, the destination in the destination record that includes the user ID of the user included in the updating instruction (step S2302). The server 200 increments the number of updates (today) in the destination record having the user ID of the user included in the updating instruction (step S2303) and returns to step S2301.

If the server 200 judges that a change of the date has been received (step S2301: DATE), in each destination record, the server 200 sets the number of updates (yesterday) to the number of updates (today) (step S2304). The server 200 sets the number of updates (today) to 0 in each of the destination records (step S2305) and returns to step S2301.

The fourth embodiment determines as the destination of a given user, the destination of the user of the portable terminal that is greatest in the received signal strength of the signal between the portable terminal carried by another user within a short distance from the given user and the portable terminal carried by the given user. In the fourth embodiment, functions and information similar to that in the first to third embodiments are given same reference numerals used in the first to third embodiments and the description thereof is omitted.

Since the destination database 210 according to the fourth embodiment is the same as the destination database 210 shown in FIG. 5, detailed description thereof is omitted.

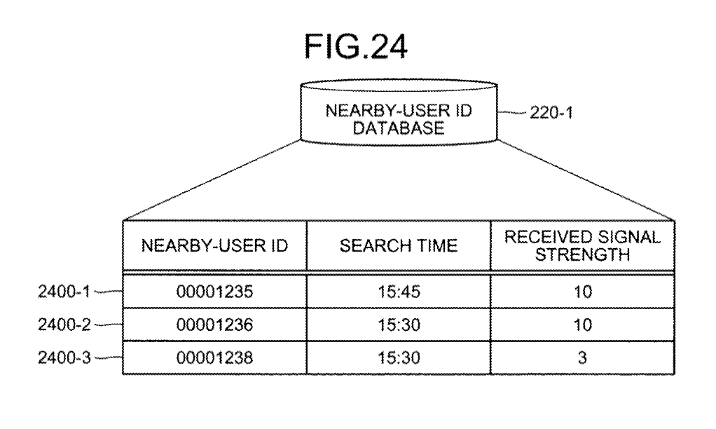

FIG. 24 is an explanatory diagram of one example of the nearby-user ID database 220-1 according to the fourth embodiment. The nearby-user ID database 220-1 has fields including nearby-user ID, search time, and received signal strength. A nearby-user ID is the user ID of the user of another portable terminal within the communication range in the radio communication by the portable terminal 201-1 using the Bluetooth I/F 403-1. Other portable terminals are referred to as nearby portable terminals. The user ID of the user of the portable terminal 201-1 is referred to as the user ID of the portable terminal 201-1.

The search time is the most recent time at which a nearby portable terminal of the portable terminal 201-1 and carried by the user identified by the user ID registered in the nearby-user ID field and the portable terminal 201-1 exchanged user IDs. The received signal strength is the received signal strength of the signal between the portable terminal 201-1 and a nearby portable terminal. The received signal strength is, for example, indicated by a received signal strength indicator (RSSI) value. The RSSI value is a numerical value within a predetermined range. In the RSSI value, a larger numerical value indicates greater strength. With information set at each field, the nearby-user information (e.g., the nearby-user records 2400-1 to 2400-3) is stored as records. It is assumed that the nearby-user ID database 220-1 is stored in a memory device such as the RAM 407-1 and the flash ROM 408-1.

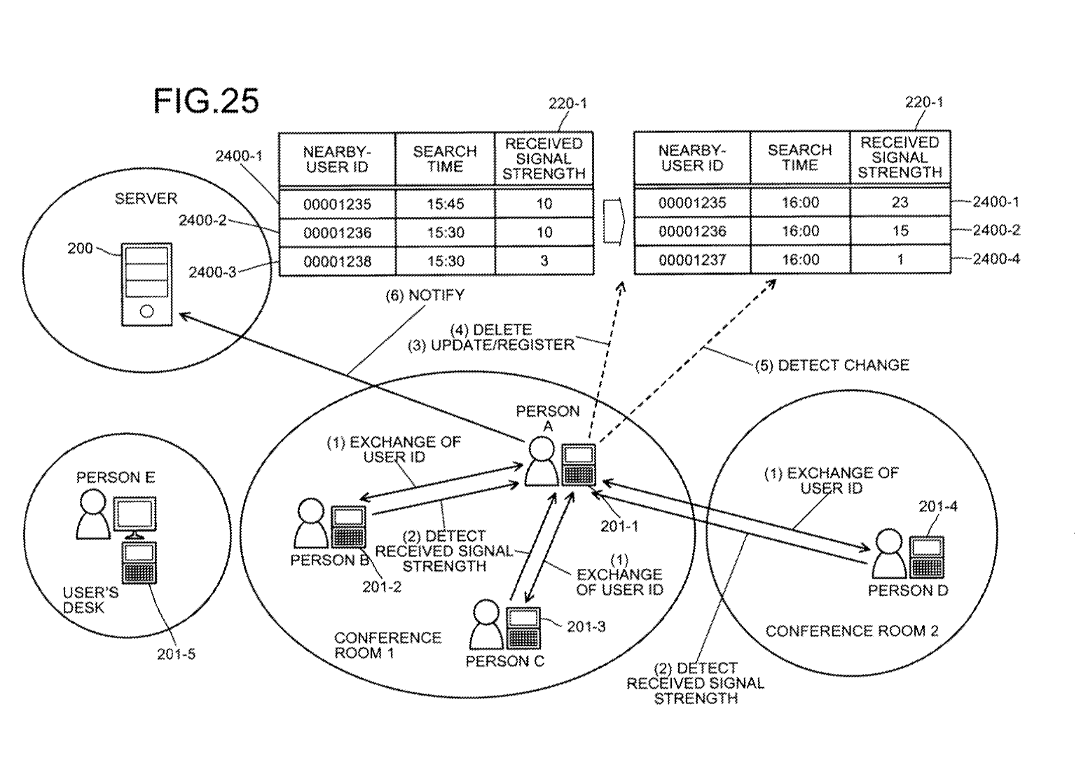

FIG. 25 is an explanatory diagram of an example of the user ID exchange between the portable terminal 201-1 and the nearby portable terminal. Since the example of the exchange of the user ID of the user of the portable terminal 201-1 and the user ID of the user of the nearby portable terminal is the same as the example described in the first embodiment, detailed description of (1) and (3) to (6) shown in FIG. 25 is omitted.

The receiver 721-1 receives from each of the portable terminals 201-2 to 201-4, the user ID of the user of the portable terminal. The detector 724-1 (2) detects the received signal strength of each of the portable terminals 201-2 to 201-4, based on the signal at the time of reception of the user ID.

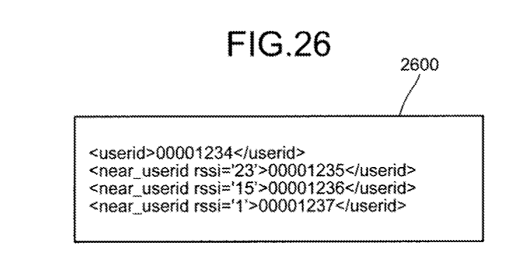

FIG. 26 is an explanatory diagram of an example of the notification information according to the fourth embodiment. Notification information 2600 is an XML document. The notification information 2600 describes the user ID of the user of the portable terminal 201-1 as the originator of the notification information 2600 between the <userid> tag and the </userid> tag.

The notification information 2600 describes the user ID of the user of one nearby portable terminal within the communication range of the portable terminal 201-1 as the originator of the notification between a <near_userid rssi=numerical value> tag and the </userid> tag. The RSSI value is set at the location of the numerical value of the <near_userid rssi=numerical value> tag. That is to say, the notification information 2600 indicates that the user ID of the user of the portable terminal 201-1 that is the originator of the notification is “00001234”. The notification information 2600 indicates that the user IDs of the users of the nearby portable terminals within the communication range of the portable terminal 201-1 that is the originator of the notification are “00001235”, “00001236”, and “00001237”.

The RSSI value of the portable terminal carried by the user identified by the user ID of “00001235” is 23 and the RSSI value of the portable terminal carried by the user identified by the user ID of “00001236” is 15. The RSSI value of the portable terminal carried by the user identified by the user ID of “00001237” is 1.

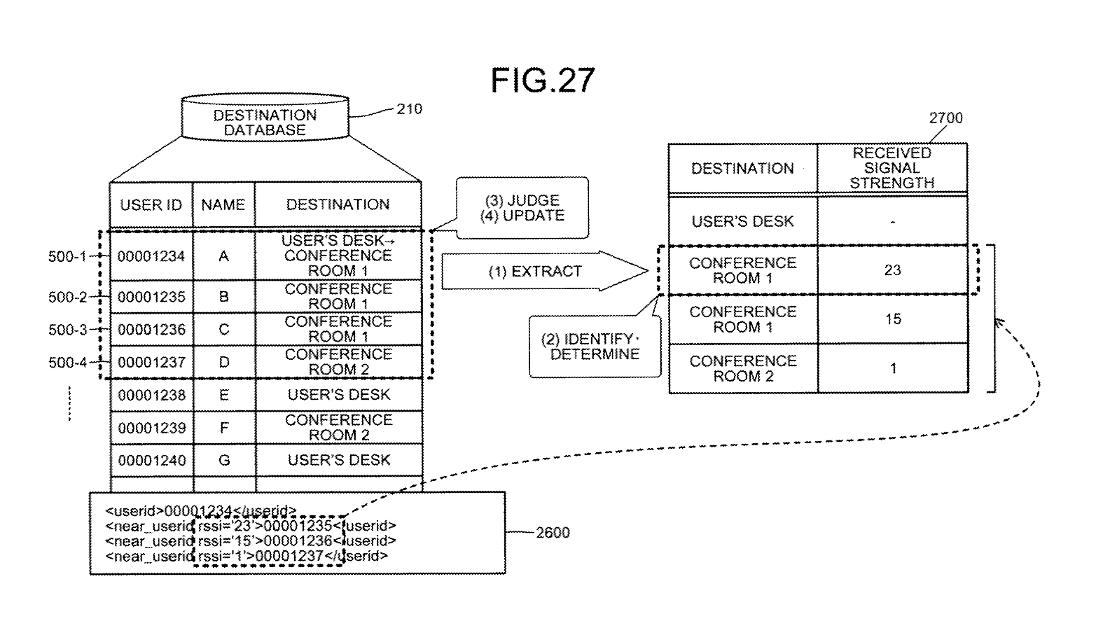

FIG. 27 is an explanatory diagram of an example of the destination determination concerning the user of the portable terminal 201-1 according to the fourth embodiment. For example, the receiver 701, upon receiving a connection from the portable terminal, receives the notification information 12000 from the portable terminal 201-1. The receiver 701 recognizes the number described between the <userid> tag and the </userid> tag included in the notification information 12000 as the user ID of the user of the portable terminal 201-1. The receiver 701 recognizes the number described between the <near_userid> tag and the </near_userid> tag included in the notification information 12000 as the user ID of the nearby portable terminal within the communication range of the portable terminal 201-1.

The identifier 702 refers to the destination database 210 and identifies the destination of the user having the greatest received signal strength, among the users of the portable terminals within the communication range of the portable terminal 201-1.

For example, the identifier 702 refers to the destination database 210 and searches for the destination record having “00001234” registered in the user ID field. The destination record 500-1 is retrieved. For example, the identifier 702 (1) extracts the destination registered in the destination field of the retrieved destination record 500-1.

For example, the identifier 702 refers to the destination database 210 and searches for the destination record having “00001235”, “00001236”, or “00001237” registered in the user ID field. The destination record 500-2, the destination record 500-3, and the destination record 500-4 are retrieved.

For example, the identifier 702 (1) extracts the destination registered in the destination field of each of the retrieved destination record 500-2 to 500-4. The identifier 702 acquires the RSSI value from the notification information 2600. The identifier 702 associates the acquired RSSI value with the extracted destination based on each user ID. A table 2700 represents results of the association.

For example, the identifier 702 (2) identifies the destination having the greatest received signal strength from the table 2700. In the table 2700, the destination having the greatest received signal strength is “conference room 1”.

The determiner 703 determines the destination of the user of the portable terminal of the greatest received signal strength identified by the identifier 702 as the destination of the user of the portable terminal 201-1. For example, the determiner 703 (2) determines “conference room 1” as the destination of the user of the portable terminal 201-1.

For example, the judger 704 (3) judges whether the destination in the retrieved destination record 500-1 and the destination of the user of the portable terminal 201-1 determined by the determiner 703 coincide. The determined destination of the user of the portable terminal 201-1 is “conference room 1”, while the destination in the destination record 500-1 is “user's desk”. Therefore, the judger 704 judges that the determined destination of the user of the portable terminal 201-1 and the destination in the destination record 500-1 do not coincide.

For example, the output unit 705 (4) updates the destination in the destination record 500-1 stored in the destination database 210 to “conference room 1”.

Since the updating processing by the input unit 711 and the updater 712 is the same as the updating processing described in the first embodiment, detailed description thereof is omitted.

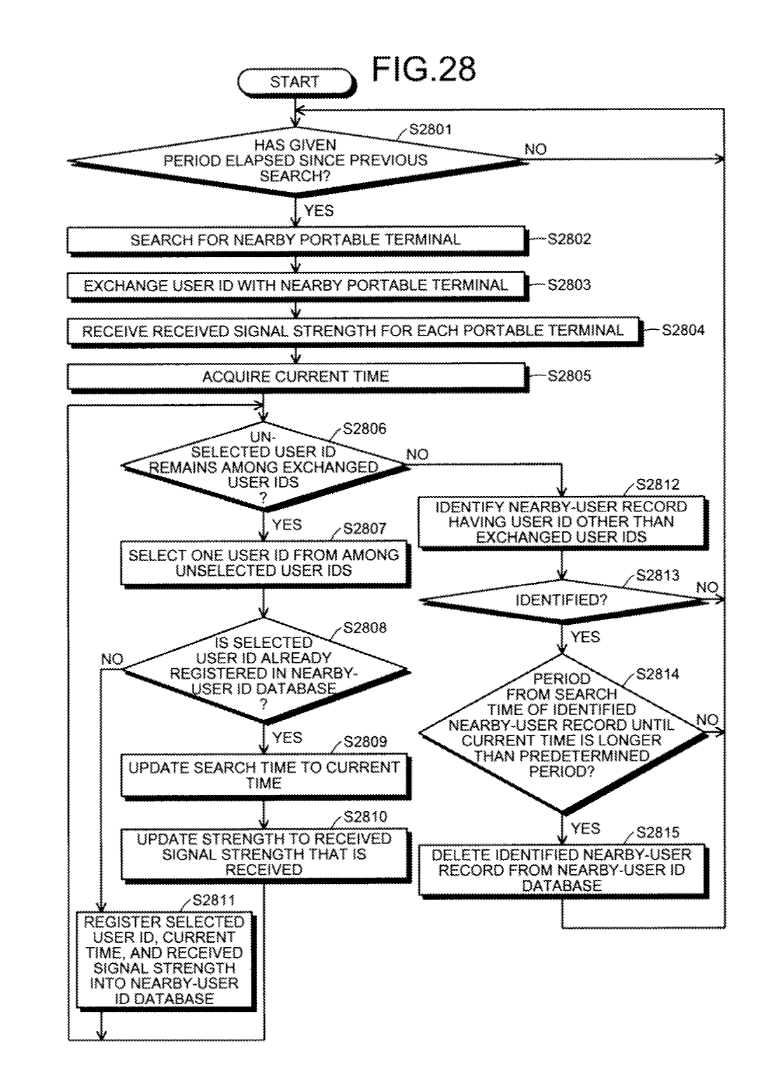

FIG. 28 is a flowchart of one example of the user ID exchange by the portable terminal 201-x according to the fourth embodiment. Firstly, the portable terminal 201-x judges whether a given period has elapsed since the previous search (step S2801). If the portable terminal 201-x judges that the given period has not elapsed since the previous search (step S2801: NO), the flow returns to step S2801. If the portable terminal 201-x judges that the given period has elapsed since the previous search (step S2801: YES), the portable terminal 201-x searches for nearby portable terminals (step S2802). A nearby portable terminal is a portable terminal that is within communication range of the portable terminal 201-x.

The portable terminal 201-x exchanges the user ID with the retrieved portable terminal (step S2803) and receives the received signal strength for each retrieved portable terminal (step S2804). The portable terminal 201-1 acquires the current time (step S2805) and judges whether there is any unselected user ID among the exchanged IDs (step S2806). If the portable terminal 201-x judges that there is an unselected user ID among the exchanged IDs (step S2806: YES), the portable terminal 201-x selects one user ID among the unselected user IDs (step S2807).

The portable terminal 201-x judges whether the selected user ID is already registered in the nearby-user ID database 220-x (step S2808). If the portable terminal 201-x judges that the selected user ID is already registered in the nearby-user ID database 220-x (step S2808: YES), the portable terminal 201-x updates the search time to the current time (step S2809), updates the strength to the received signal strength that is received (step S2810), and returns to step S2806.

If the portable terminal 201-x judges that the selected user ID is not yet registered in the nearby-user ID database 220-x (step S2808: NO), the portable terminal 201-x registers the selected user ID, the current time, and the received signal strength into the nearby-user ID database 220-x (step S2811) and returns to step S2806.

If the portable terminal 201-x judges that there is no unselected user ID among the exchanged IDs (step S2806: NO), the portable terminal 201-x identifies the nearby-user record having a user ID other than the exchanged user IDs (step S2812). The portable terminal 201-x refers to the nearby-user ID database and judges whether a nearby-user record having the user ID other than the exchanged user IDs has been identified (step S2813).

If the portable terminal 201-x judges that a nearby-user record having a user ID other than the exchanged user IDs has been identified (step S2813: YES), the flow proceeds to step S2814. The portable terminal 201-x judges whether the period from the search time of the identified nearby-user record until the current time is longer than a predetermined period (step S2814).

If the portable terminal 201-x judges that the time from the search time of the identified nearby-user record until the current time is longer than the predetermined period (step S2814: YES), the portable terminal 201-x deletes the identified nearby-user record from the nearby-user ID database 220-x (step S2815) and returns to step S2801.

At step S2813, if the portable terminal 201-x judges that a nearby-user record having a user ID other than the exchanged user IDs has not been identified (step S2813: NO), the flow returns to step S2801. At step S2814, if the portable terminal 201-x judges that the time from the search time of the identified nearby-user record until the current time is not longer than the predetermined period (step S2814: NO), the flow returns to step S2801.

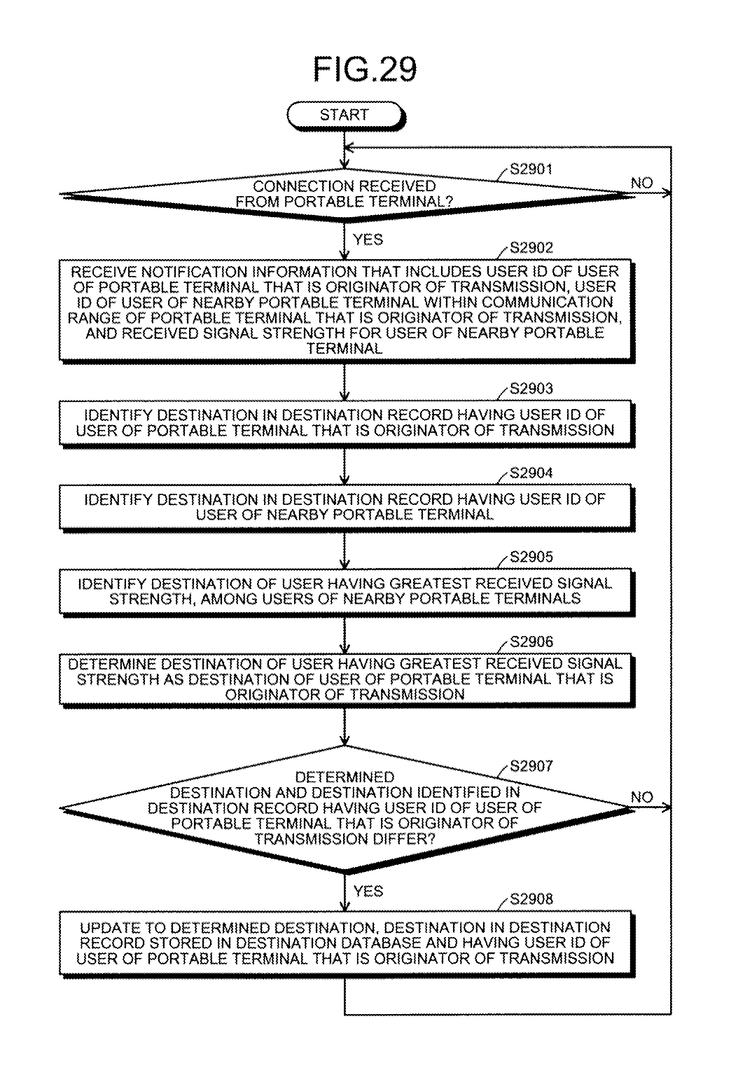

FIG. 29 is a flowchart of one example of processing of the destination determination by the server 200 according to the fourth embodiment. The server 200 firstly judges whether a connection from the portable terminal has been received (step S2901). If the server 200 judges that a connection from the portable terminal has not been received (step S2901: NO), the flow returns to step S2901. If the server 200 judges that a connection from the portable terminal has been received (step S2901: YES), the flow proceeds to step S2902. The server 200 receives the notification information 2600 that includes the user ID of the user of the portable terminal that is the originator of the transmission, the user IDs of the users of nearby portable terminals within the communicating distance of the portable terminal that is the originator of the transmission, and the received signal strengths of the users of the nearby portable terminals (step S2902). The received signal strength of the users is the received signal strength of the signal between the portable terminal that is the originator of the transmission and the nearby portable terminals.

The server then identifies the destination in the destination record having the user ID of the user of the portable terminal that is the originator of the transmission (step S2903). The server 200 identifies the destination in the destination records having the user ID of the users of the nearby portable terminals (step S2904). The server 200 identifies the destination of the user having the greatest received signal strength among the users of the nearby portable terminals (step S2905) and determines the destination of the user having the greatest received signal strength as the destination of the user of the portable terminal that is the originator of the transmission (step S2906). The server 200 judges whether the destination in the destination record having the user ID of the user of the portable terminal that is the originator of the transmission and the determined destination differ (step S2907).

If the server 200 judges that the destination in the destination record having the user ID of the user of the portable terminal that is the originator of the transmission and the determined destination differ (step S2907: YES), the flow proceeds to step 2908. The server 200 updates to the determined destination, the destination in the destination record having the user ID of the user of the portable terminal that is the originator of the transmission that is stored in the destination database 210 (step S2908) and returns to step 2901.

If the server 200 judges that the destination in the destination record having the user ID of the user of the portable terminal that is the originator of the transmission and the determined destination coincide (step S2907: NO), the flow returns to 2901.

Since the updating processing by the server 200 is the same as the updating processing by the server 200 described in the first embodiment, detailed description thereof is omitted.

The fifth embodiment indicates an example of combining a given user's destination determining methods of the first to the fourth embodiments.

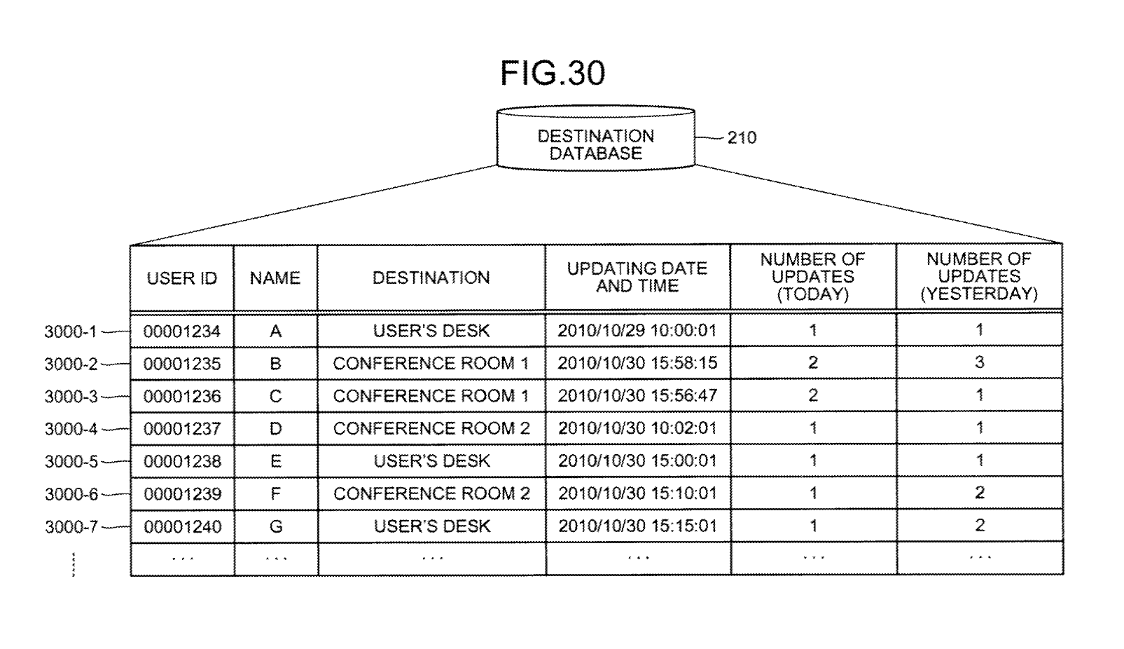

FIG. 30 is an explanatory diagram of one example of the destination database 210 according to the fifth embodiment. The destination database 210 has the destination record of each user. The destination database 210 has fields including user ID, name, destination, updating date and time, number of updates (today), and number of updates (yesterday). A user ID is identification information to identify a user. The user ID is, for example, a number that differs from one user to another, such as an employee number.

A name is the name of the user identified by the user ID. While the name is not used in this destination determination processing, it is shown in the destination database 210 for easier understanding. A destination is the destination of the user identified by the user ID. For example, place names such as the user's desk, employee lounge, and the names of conference rooms can be given as the destination. The updating date and time is the date and time at which the user identified by the user ID updated the destination. The number of updates (today) is the number of times today the user identified by the user ID updated the destination. The number of updates (yesterday) is the number of times yesterday the user identified by the user ID updated the destination.

With information entered into each field, destination information (e.g., destination records 3000-1 to 3000-6) is stored as records. It is assumed that the destination database 210 is stored in a memory device such as the RAM 303, the magnetic disk 305, and the optical disk 307. Since the nearby-user ID database according to the fifth embodiment is the same as the nearby-user ID database shown in FIG. 24, detailed description thereof is omitted.

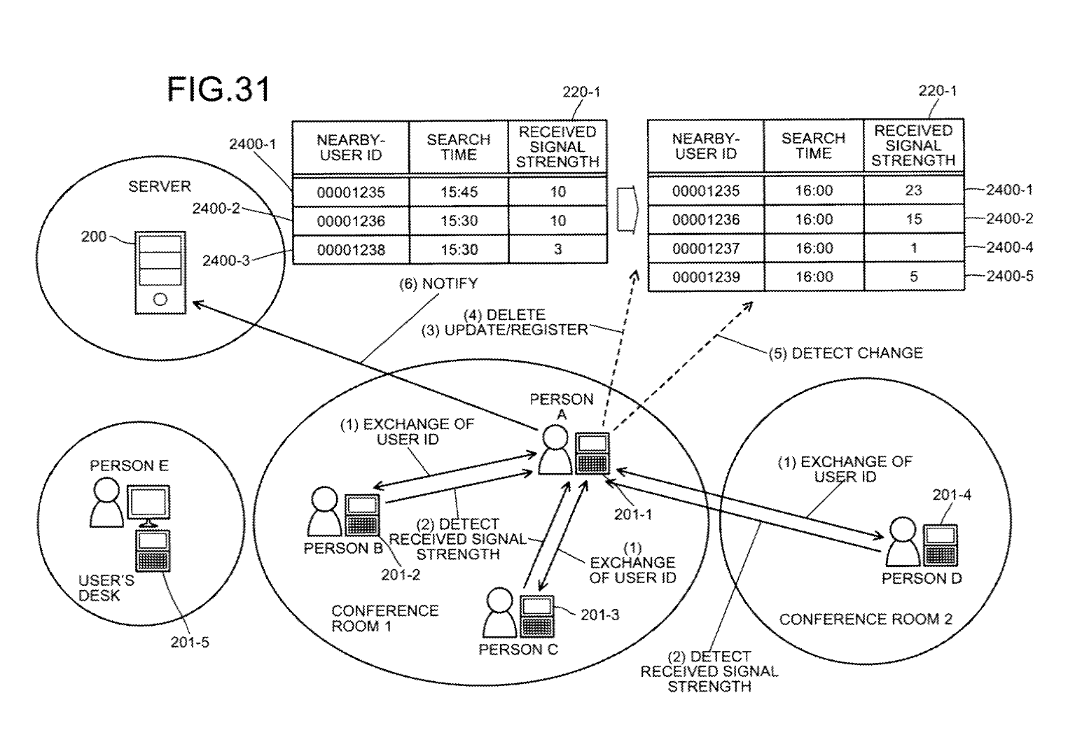

FIG. 31 is an explanatory diagram of an example of the exchange of the user ID between the portable terminal 201-1 and the nearby portable terminal according to the fifth embodiment. For example, the transmitter 722-1 uses the Bluetooth I/F 403-1 and notifies surrounding portable terminals of information whether communication with the portable terminal 201-1 is possible. A surrounding portable terminal is a portable terminal within communication range and capable of radio communication via the Bluetooth I/F 403-1 of the portable terminal 201-1. The receivers 721-2 to 721-4 (portable terminals 201-2 to 201-4) receive from the portable terminal 201-1, information indicating whether communication is possible, and the transmitters 722-2 to 722-4 (portable terminals 201-1 to 201-4) transmit information indicating the ability to communicate to the portable terminal 201-1.

Upon receiving from the portable terminals 201-2 to 201-4, the information indicating the capability of communicating, the receiver 721-1 and the transmitter 722-1 (1) exchange user IDs with each of the portable terminals 201-2 to 201-4. The receiver 721-1 receives “00001235”, “00001236”, and “00001237” through the exchange of the user ID.

The detector 724-1 (2) detects the RSSI value of the signal between the portable terminal 201-1 and the portable terminals 201-2 to 201-4 when the receiver 721-1 receives the user ID from each of the portable terminals 201-2 to 201-4. The registrar 723-1 acquires the current time.

The registrar 723-1 refers to the nearby-user ID database 220-1 and identifies the nearby-user information that includes any one of “00001235”, “00001236”, “00001237”, and “00001239”. The nearby-user record 2400-1 has “00001235” in the nearby-user ID field and the nearby-user record 2400-2 has “00001236” in the nearby-user ID field.

The registrar 723-1 (3) updates to the current time, the time in the search time field of the nearby-user record 2400-1 and the time in the search time field of the nearby-user record 2400-2. It is assumed that the current time is 16:00. The registrar 723-1 (3) updates the value in the received signal strength field of the nearby-user record 2400-1 to the RSSI value of the signal between the portable terminal 201-1 and the portable terminal 201-2 that is detected by the detector 724-1. The registrar 723-1 (3) updates the value in the received signal strength field of the nearby-user record 2400-2 to the RSSI value of the signal between the portable terminal 201-1 and the portable terminal 201-3 that is detected by the detector 724-1.

Since the nearby-user information that includes “00001237” is not identified in the nearby-user ID database 220-1, the registrar 723-1 (3) sets “00001237” to the nearby-user ID field of the nearby-user ID database 220-1. The registrar 723-1 sets the current time to the search time field of the nearby-user ID database 220-1. The registrar 723-1 sets the RSSI value of the signal between the portable terminal 201-1 and the portable terminal 201-4 that is detected by the detector 724-1 as the value of the received signal strength field of the nearby-user ID database 220-1, newly preparing a nearby-user record 2400-4.

Since the nearby-user information that includes “00001239” is not identified in the nearby-user ID database 220-1, the registrar 723-1 (3) registers “00001239” into the nearby-user ID field of the nearby-user ID database 220-1. The registrar 723-1 registers the current time into the search time field of the nearby-user ID database 220-1. The registrar 723-1 sets the RSSI value of the signal between the portable terminal 201-1 and the portable terminal 201-6 that is detected by the detector 724-1 as the value of the received signal strength field of the nearby-user ID database 220-1, newly preparing a nearby-user record 2400-5.

For example, the registrar 723-1 refers to the nearby-user ID database 220-1 and identifies the nearby-user information that includes a user ID other than the exchanged IDs. For example, the nearby-user record 2400-3 is identified that has “00001238” registered in the nearby-user ID field.

The registrar 723-1 judges whether the time from the time registered in the search time field of the identified nearby-user record 2400-3 until the current time is longer than a predetermined period. For example, the predetermined period is set at 15 [minutes]. The time is 30 [minutes] and therefore, is judged to be longer than the predetermined period. The registrar 273-1 (4) deletes the nearby-user record 2400-3 from the nearby-user ID database 220-1. Though this is not shown, the registrar 273-1 (4) does not delete the nearby-user record 2400-3 from the nearby-user ID database when it is judged that the time is not longer than the predetermined period.

The transmitter 722-1 (5) detects a change in the nearby-user ID database 220-1. The transmitter 722-1 (6) transmits to the server 200 by way of the network 314, notification information having the user IDs that are registered in the nearby-user ID field of the nearby-user ID database 220-1 and the user ID of the user of the portable terminal 201-1.

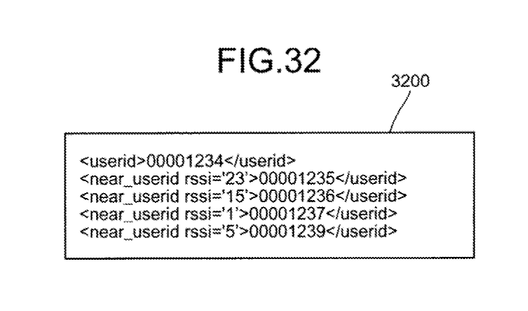

FIG. 32 is an explanatory diagram of an example of the notification information according to the fifth embodiment. The notification information 3200 is an Extensible Markup Language (XML) document. The notification information 3200 describes, between a <userid> tag and a </userid> tag, the user ID of the user of the portable terminal 201-1 that is the originator of the notification information 3200.

The notification information 3200 describes the user ID of the user of one nearby portable terminal within the communication range of the portable terminal 201-1 as the originator of the notification between the <near_userid rssi=numerical value> tag and the </userid> tag. The RSSI value is set at the location of the numerical value of the <near_userid rssi=numerical value> tag. That is to say, the notification information 3200 indicates that the user ID of the user of the portable terminal 201-1 that is the originator of the notification is “00001234”. The notification information 3200 indicates that the user IDs of the users of the nearby portable terminals within the communication range of the portable terminal 201-1 that is the originator of the notification are “00001235”, “00001236”, “00001237”, and “00001239”.

The RSSI value of the portable terminal carried by the user identified by the user ID of “00001235” is 23 and the RSSI value of the portable terminal carried by the user identified by the user ID of “00001236” is 15. The RSSI value of the portable terminal carried by the user identified by the user ID of “00001237” is 1 and the RSSI value of the portable terminal carried by the user identified by the user ID of “00001239” is 5.

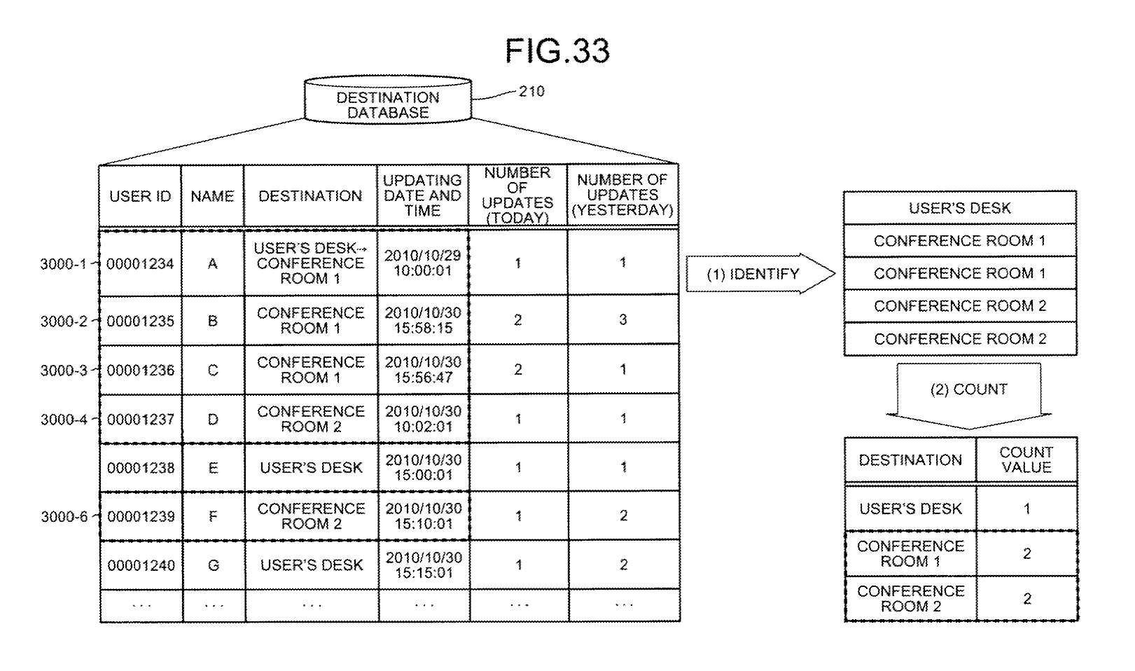

FIG. 33 is an explanatory diagram (1 of 2) of an example of determining the destination of the user of the portable terminal 201-1 according to the fifth embodiment. Firstly, the receiver 701 and the identifier 702 use the determination method described in the first embodiment to identify the destination of the highest count among the destinations of the users of the nearby portable terminals.

Since the processing of (1) and (2) depicted in FIG. 33 is the same as the processing described in the first embodiment, detailed description thereof is omitted. In a table 3300, “user's desk” has a count value of 1, “conference room 1” has a count value of 2, and “conference room 2” has a count value of 2. Since “conference room 1” and “conference room 2” have the same count value, the destination of the highest count cannot be identified uniquely.

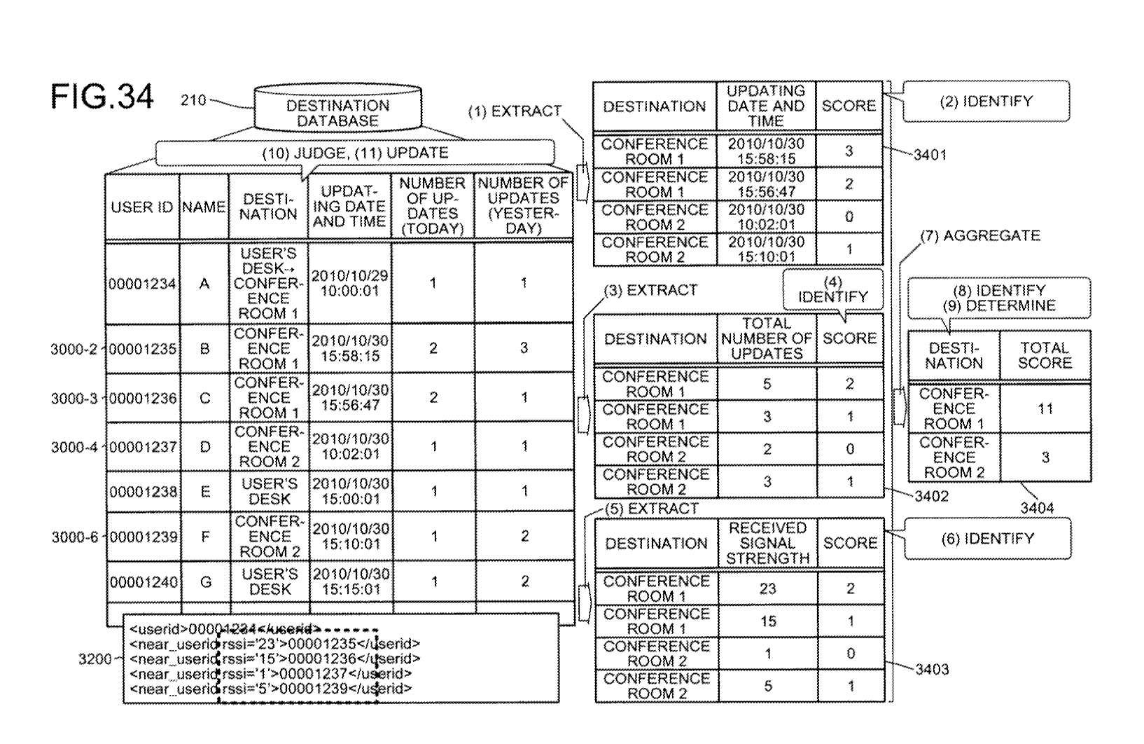

FIG. 34 is an explanatory diagram (2 of 2) of an example of determining the destination of the user of the portable terminal 201-1 according to the fifth embodiment. For example, the identifier 702 refers to the destination database 210 and identifies the destination record having “conference room 1” or “conference room 2” in the destination field, among the destination records 3000-1 to 3000-4 and the destination record 3000-6. The destination records 3000-2 to 3000-4 and the destination record 3000-6 are identified.

For example, the identifier 702 (1) extracts the updating date and time registered in the updating date and time field of the identified destination records. The identifier 702 (2) arranges the extracted updating dates and times in chronological order and assigns points of 0 to 3 to the extracted updating dates and times in chronological order.

For example, the identifier 702 (3) extracts the number of updates (today) registered in the number of updates (today) field of the identified destination record. The identifier 702 (3) extracts the number of updates (yesterday) registered in the number of updates (yesterday) field of the identified destination record. For each user, the identifier 702 sums the extracted number of updates (today) and number of updates (yesterday). The identifier 702 (4) arranges the calculated sums in ascending order and assigns points of 0 to 3 to the calculated sums in ascending order.

For example, the identifier 702 (5) extracts the RSSI value of the notification information 3200 in association with the destination in the identified destination record, based on the user ID registered in the user ID field of the identified destination record. The identifier 702 (6) arranges the destinations in ascending order of the received signal strength.

For example, the identifier 702 assign 0 points if the received signal strength is less than or equal to a first predetermined value, assigns 2 points if the received signal strength is greater than or equal to a second predetermined value, and assigns 1 point if the received signal strength is greater than the first predetermined value and is smaller than the second predetermined value. For example, the first predetermined value is 4 and the second predetermined value is 14.

In the tables 3401 to 3403, a score is registered for each destination. Identifier 702 aggregates the scores for each identical destination by calculating a total score for each identical destination. In the table 3404, the total score is registered for each identical destination. For example, the identifier 702 (8) identifies the destination of the highest total score. For example, the determiner 703 (9) determines the identified destination as the destination of the user of the portable terminal 201-1.

For example, the judger 704 (10) judges whether the destination in the destination record 3000-1 identified by the identifier 702 and the destination of the user of the portable terminal 201-1 determined by the determiner 703 coincide. The determined destination of the user of the portable terminal 201-1 is “conference room 1”, while the destination in the destination record 3000-1 is “user's desk”. Therefore, it is judged that the determined destination of the user of the portable terminal 201-1 and the destination in the destination record 3000-1 do not coincide.

The output unit 705 outputs results of determination by the determiner 703, associated with the user ID of the user of the portable terminal 201-1. For example, the output unit 705 (11) updates to “conference room 1”, the destination in the destination record 3000-1 stored in the destination database 210.

In the above example, when there are plural destinations of the highest count, points are assigned based on other degree of accuracy to determine the destination of the user of the portable terminal 201-1. However, configuration is not limited hereto, when there are plural users having the most recent updating date and time, points may be assigned based on other probabilities to determine the destination of the user of the portable terminal 201-1.

When there are plural users having the largest number of updates, points may be assigned based on probabilities to determine the destination of the user of the portable terminal 201-1. When there are plural users having the greatest received signal strength, points may be assigned based on other probabilities to determine the destination of the user of the portable terminal 201-1.

In the first to the fourth embodiments, the degree of accuracy with which to determine the destination of the user of the portable terminal 201-1 differs from one embodiment to another. Consequently, since it is not uniquely determined which degree of accuracy is the best, it is acceptable to combine degrees of accuracy in any manner whatsoever.

Since the processing of exchanging the user ID by the portable terminal 201-1 according to the fifth embodiment is the same as the processing of exchanging the user ID by the portable terminal 201-1 according to the fourth embodiment, detailed description thereof is omitted.

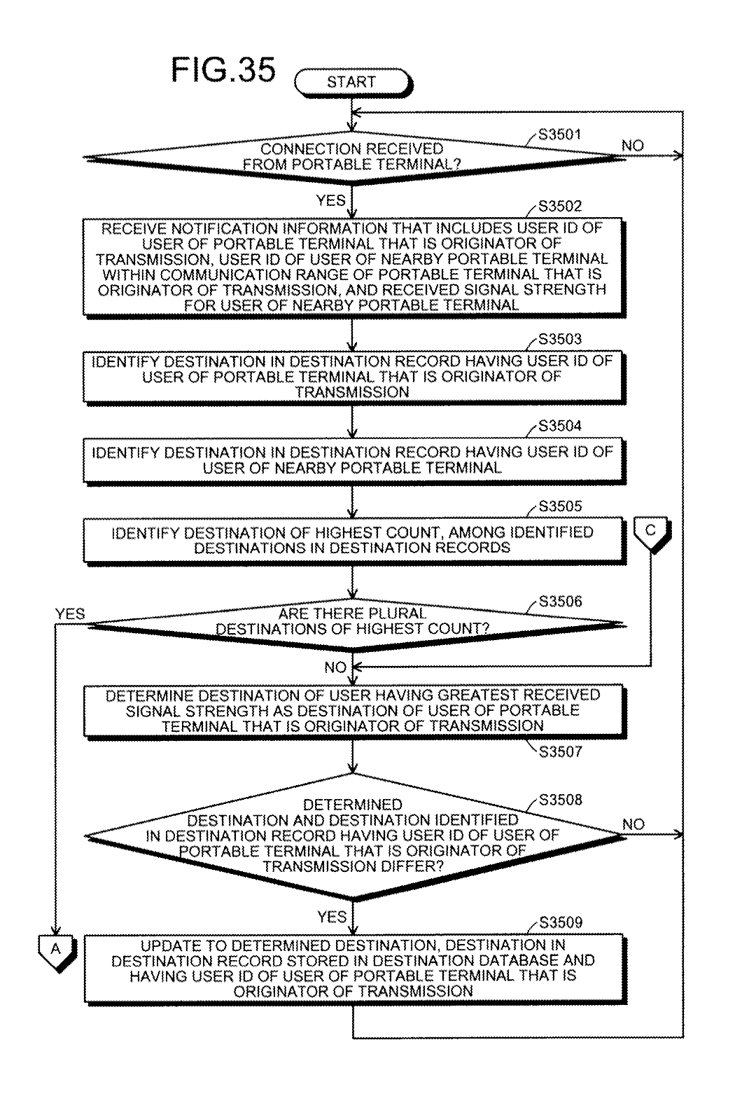

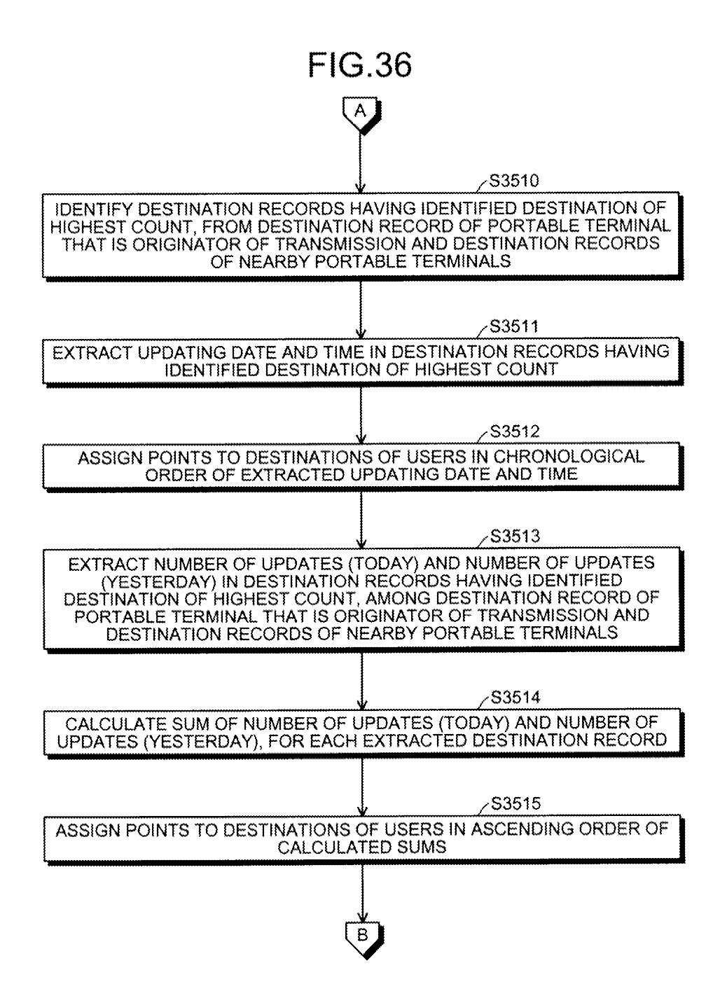

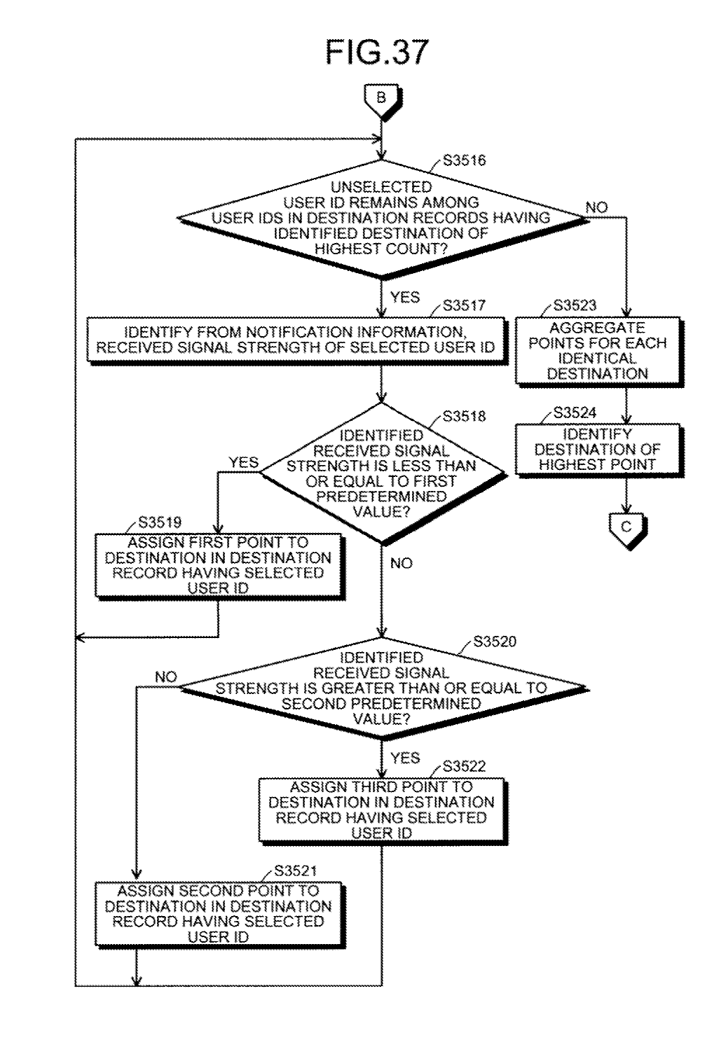

FIGS. 35 to 37 are flowcharts of processing of the destination determination by the server 200 according to the fifth embodiment. The server 200 firstly judges whether a connection from the portable terminal has been received (step S3501). If the server 200 judges that a connection from the portable terminal has not been received (step S3501: NO), the flow returns to step S3501.

If the server 200 judges that a connection from the portable terminal has been received (step S3501: YES), the flow proceeds to step S3502. The server 200 receives, from the portable terminal, the notification information 900 that includes the user ID of the user of the portable terminal that is the originator of the transmission, the user IDs of the users of nearby portable terminals within the communicating distance of the portable terminal that is the originator of the transmission, and the received signal strengths of the users of the nearby portable terminals (step S3502).

The server 200 identifies the destination in the destination record having the user ID of the user of the portable terminal that is the originator of the transmission (step S3503) and identifies the destination in the destination record having the user ID of the user of the nearby portable terminal (step S3504). The server 200 identifies the destination of the highest count, among the identified destinations in the destination records (step S3505).

The server 200 judges whether there are plural destinations of the highest count (step S3506). If the server 200 judges that there are not plural destinations of the highest count (step S3506: NO), the server 200 determines the identified destination as the destination of the user of the portable terminal that is the originator of the transmission (step S3707).

If the server 200 judges that the destination in the destination record having the user ID of the user of the portable terminal that is the originator of the transmission and the determined destination differ (step S3508) If the server 200 judges the two destinations differ (step S3508: YES), the flow proceeds to step S3509.

The server 200 updates to the determined destination, the destination in the destination record having the user ID of the user of the portable terminal that is the originator of the transmission that is stored in the destination database 210 (step S3509) and returns to step S3501. If the server 200 judges that the destination in the destination record having the user ID of the user of the portable terminal that is the originator of the transmission and the determined destination coincide (step S3508: NO), the flow returns to S3501.

If the server 200 judges that there are plural destinations of the highest count (step S3506: YES), the server 200 identifies the destination records having the identified destination of the highest count, from the destination record of the portable terminal that is the originator of the transmission and the destination records of the nearby portable terminals (step S3510). The destination record of the portable terminal that is the originator of the transmission is the destination record that includes the user ID of the user of the portable terminal that is the originator of the transmission and the destination records of the nearby portable terminals are the destination records having the user IDs of the users of the nearby portable terminals.

The server 200 extracts the updating date and time in the destination records having the identified destination of the highest count (step S3511) and assigns points to the destinations of the users in chronological order of the extracted updating date and time (step S3512).

The server 200 extracts the number of updates (today) and the number of updates (yesterday) of the destination records having the identified destination of the highest count, among the destination record of the portable terminal that is the originator of the transmission and the destination records of the nearby portable terminals (step S3513).

The server 200 sums the number of updates (today) and the number of updates (yesterday), for each extracted destination record (step S3514) and assigns points to the destinations of the users in ascending order of the calculated sums (step S3515).

The server 200 judges whether there is any unselected user ID among the user IDs of the destination record having the identified destination of the highest count (step S3516). If the server 200 judges that there is an unselected user ID among the user IDs of the destination record having the identified destination of the highest count (step S3516: YES), the server 200 identifies the received signal strength of the selected user ID from the notification information (step S3517).

The server 200 judges whether the identified received signal strength is at most the first predetermined value (step S3518). If the server 200 judges that the identified received signal strength is less than or equal to the first predetermined value (step S3518: YES), the server 200 assigns a first point to the destination in the destination record having the selected user ID (step S3519) and returns to step S3516. For example, the first point is 0 points.

If the server 200 judges that the identified received signal strength is not less than or equal to the first predetermined value (step S3518: NO), then the server 200 judges whether the identified received signal strength is at least the second predetermined value (step S3520). If the server 200 judges that the identified received signal strength is not greater than or equal to the second predetermined value (step S3520: NO), then the server 200 assigns a second point to the destination in the destination record having the selected user ID (step S3521) and returns to step S3516.

If the server 200 judges that the identified received signal strength is greater than or equal to the second predetermined value (step S3520: YES), the server 200 assigns a third point to the destination in the destination record having the selected user ID (step S3522) and returns to step S3516.

At step S3516, if the server 200 judges that there is no unselected user ID among the user IDs of the destination record having the identified destination of the highest count (step S3516: NO), the server 200 aggregates points for each identical destination (step S3523). The server 200 identifies the destination of the highest point (step S3524) and proceeds to step S3507.

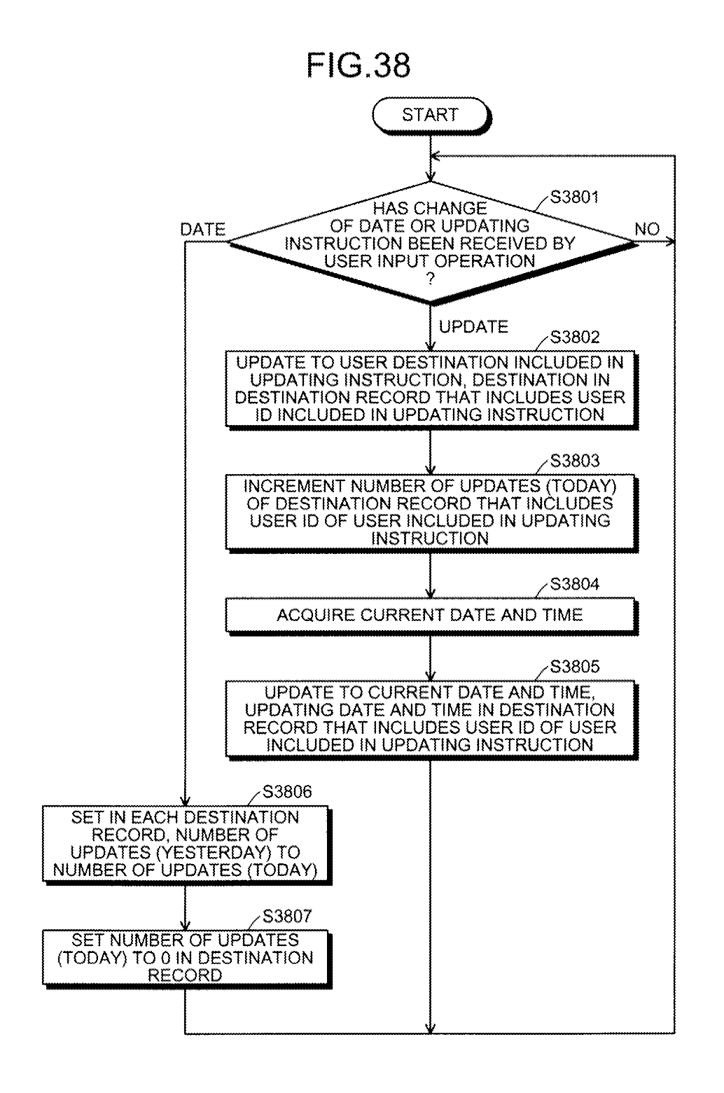

FIG. 38 is a flowchart of the updating processing by the server 200 according to the fifth embodiment. The server 200 judges whether an updating instruction by a user input operation or a change of the date has been received (step S3801). If it is judged that neither an updating instruction by a user input operation nor a change of the date has been received (step S3801: NO), the flow returns to step S3801.

If the server 200 judges that the updating instruction by the user input operation has been received (step S3801: UPDATE), then the server 200 refers to the destination database 210 and updates to the destination of the user included in the updating instruction, the destination in the destination record that includes the user ID of the user included in the updating instruction (step S3802). The server 200 increments the number of updates (today) in the destination record that includes the user ID of the user included in the updating instruction (step S3803). The server 200 acquires the current time (step S3804), updates the updating date and time in the destination record that includes the user ID of the user included in the updating instruction to the acquired current time (step S3805), and returns to step S3801.

At step 3801, if the server 200 judges that the change of date has been received (step S3801: DATE), the server 200 sets the number of updates (yesterday) in the destination record to the number of updates (today) in each destination record (step S3806). The server 200 sets the number of updates (today) to 0 (step S3807) and returns to step S3801.

While in the first to the fifth embodiments, the portable terminal 201-1 requests the server 200 to determine the destination, the server 200 need not perform the destination determining processing at the same time when plural portable terminals request the server 200 to determine the destination at the same time.

As described above in the first to the fifth embodiments, according to the destination determining program and the destination determining method, the whereabouts of a user can be estimated based on the destination of a user of a second portable terminal in a short distance from a first portable terminal held by the user. This makes it possible to identify the destination of the user even if the user forgets to make updating to the destination board or even if, after updating of the destination on the destination board, an employee heads for a place different from such a destination. Further, with the identified destination of the user reflected on the destination board, the destination of the user can automatically be updated on the destination board. Since the whereabouts of the user is estimated without installing expensive devices such as the PC and the RFID, the expenses can be reduced. Since the name of place is identified as the destination of the user, there is no need any longer for the processing of associating each device of the PC, the RFID, etc., with the name of place or the processing of associating the information of longitude, latitude, etc., with the name of place.

The whereabouts of the user is estimated based on the destination of the user on the destination board and the destination of the holder of the second portable terminal. This makes it possible to automatically update the destination of the user, relying on updating by the user as well.

As described in the first embodiment, among the destination of the user and the destinations of the holders of the second portable terminals, the destination of the highest count is estimated as the whereabouts of the user. The most frequently set destination among the destinations of plural users can highly be relied on and the destination of the user can automatically be updated.

As described in the second embodiment, among the updating date and time at which the user updated the destination and the updating dates and times at which the holders of the second portable terminals updated the destination, the destination of the most recent updating date and time is estimated as the whereabouts of the user. The destination of the user can automatically be updated based on the destination whose updating date and time is new and whose reliability is high.

As described in the third embodiment, the whereabouts of the user is estimated based on the frequency of updating the destination board of the user and the frequency of updating the destination board of the holders of the second portable terminals. The user of a high updating frequency can surely update the destination board and the destination of the user can automatically be updated by the destination of a high reliability.

As described in the fourth embodiment, the whereabouts of the user is estimated based on the received signal strength of the signal between the first portable terminal and the second portable terminal. For example, since the received signal strength of other user in the room different from the one which the user is in can become weak, the destination of the user can be prevented from being automatically updated by an erroneous destination.

With the destination on the destination board updated by the user input operation, the accuracy of the destination registered on the destination board can be enhanced.

The destination determining method described in the present embodiment may be implemented by executing a prepared program on a computer such as a personal computer and a workstation. The destination determining program is stored on a computer-readable recording medium such as a hard disk, a flexible disk, a CD-ROM, an MO, and a DVD, read out from the recording medium, and executed by the computer. The program may be distributed through a network such as the Internet. However, the computer-readable recording medium does not include a transitory medium such as a propagation signal.

One aspect of the present invention effects automatic updating of the destination of a user on a destination board.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable medium storing therein a destination determining program that causes a computer having access to a database that stores therein identification information that is for each user among a plurality of users and is associated with a destination of each user, to execute a process, the process comprising:
receiving from a first portable terminal of a given user among the plurality of users, the identification information of the given user and receiving from each second portable terminal within a communication range of the first portable terminal, the identification information of each user of the second portable terminals;
identifying, by referring to the database, the destination of each user of the second portable terminals, stored in association with the identification information received for each user of the second portable terminals;
determining the destination of the given user, based on the identified destinations; and
outputting in association with the received identification information of the given user, results obtained at the determining.

2. The computer-readable medium according to claim 1, wherein
the identifying includes referring to the database, and further identifying the destination of the given user, stored in association with the identification information of the given user, and
the determining includes determining the destination of the given user, based on the destination of each user of the second portable terminals and the destination of the given user.

3. The computer-readable medium according to claim 2, wherein
the determining includes determining, as the destination of the given user, the destination of the highest count among the destinations of each user of the second portable terminals and the destination of the given user.

4. The computer-readable medium according to claim 2, wherein
the database stores in association with one another, the identification information of each user, the destination of each user, and updating date and time at which the destination of each user was updated,
the identifying includes referring to the database and further identifying the destination of the most recent updating date and time among the destinations of each user and the destination of the given user, and
the determining includes determining, as the destination of the given user, the destination of the most recent updating date and time identified at the identifying.

5. The computer-readable medium according to claim 2, wherein
the database stores, in association with one another, the identification information of each user, the destination of each user, and the number of updates of the destination of each user,
the identifying includes referring to the database and further identifying the destination of the user of the largest number of updates, among the users of the second portable terminals and the given user, and
the determining includes determining, as the destination of the given user, the destination of the user of the largest number of updates identified at the identifying.

6. The computer-readable medium according to claim 1, wherein
the receiving includes receiving from the first portable terminal, received signal strength of a signal between the first portable terminal and the second portable terminals,
the identifying includes referring to the database and identifying the destination of the user for which the received signal strength is greatest, among the users of the second portable terminals, and
the determining includes determining, as the destination of the given user, the destination of the user for which the received signal strength is greatest.

7. The computer-readable medium according to claim 1, wherein
the outputting includes updating to the destination of the given user determined at the determining, the destination of the given user, stored in the database.

8. The computer-readable medium according to claim 1, the process further comprising:
receiving the identification information of the given user and the destination of the given user through an input operation by the given user; and
updating to the destination of the given user received at the receiving, the destination of the given user, stored in the database in association with the identification information received at the receiving.

9. The computer-readable medium according to claim 1, the process further comprising:
judging whether the destination of the given user identified at the identifying and the destination of the given user determined at the determining coincide, wherein
the outputting includes outputting information indicating non-coincide in association with the identification information of the given user, when the destination of the given user identified at the identifying and the destination of the given user determined at the determining are judged at the judging to not coincide.

10. A destination determining method executed by a computer having access to a database that stores therein identification information that is for each user among a plurality of users and is associated with a destination of each user, the destination determining method comprising:
receiving from a first portable terminal of a given user among the plurality of users, the identification information of the given user and receiving from each second portable terminal within a communication range of the first portable terminal, the identification information of each user of the second portable terminals;
identifying, by referring to the database, the destination of each user of the second portable terminals, stored in association with the identification information received for each user of the second portable terminals;
determining the destination of the given user, based on the identified destinations; and
outputting in association with the received identification information of the given user, results obtained at the determining.
